(19) United States
(12) Patent Application Publication
(10) Pub. No.: US 2023/0034102 A1
(43) Pub. Date: Feb. 2, 2023

(54) Maintenance Method Of Liquid Discharging Apparatus

(71) Applicant: SEIKO EPSON CORPORATION, Tokyo (JP)

(72) Inventor: Kotaro YOSHIDA, Shiojiri (JP)

(21) Appl. No.: 17/873,200

(22) Filed: Jul. 26, 2022

(30) Foreign Application Priority Data
Jul. 27, 2021 (JP) 2021-122328

(51) Int. Cl. B41J 2/165; B41J 2/175

(52) U.S. Cl. CPC B41J 2/16526; B41J 2/16535; B41J 2/17556

(57) ABSTRACT

A maintenance method for a liquid discharging apparatus including a liquid discharging head. The liquid discharging apparatus executes a printing process including a discharging process in which the liquid discharged from the liquid discharging head lands on the medium, and a maintenance process in which the liquid is discarded from the liquid discharging head. The maintenance method includes: counting a unit period number, which is the number of ended unit periods among a plurality of unit periods obtained by dividing a period required for the printing process in accordance with a first condition; executing the maintenance process when the unit period number reaches a defined number; acquiring viscosity information related to viscosity of the liquid inside the liquid discharging head; and decreasing the unit period number when the viscosity information satisfies a second condition.

The present application is based on, and claims priority from JP Application Serial Number 2021-122328, filed Jul. 27, 2021, the disclosure of which is hereby incorporated by reference herein in its entirety.

### BACKGROUND

### 1. Technical Field

The present disclosure relates to a maintenance method of a liquid discharging apparatus.

### 2. Related Art

In a liquid discharging apparatus that discharges liquid such as ink to a medium such as printing paper, for example, thickening of the liquid due to evaporation or the like of water contained in the liquid becomes a problem. JP-A-2014-233904 discloses a liquid discharging apparatus that periodically executes a maintenance process of driving a drive element to discard ink inside a liquid discharging head.

However, in the above-described liquid discharging apparatus in the related art, liquid may be excessively discarded in the maintenance process.

### SUMMARY

In order to solve the above problems, one aspect of a maintenance method for a liquid discharging apparatus according to the present disclosure is a maintenance method for a liquid discharging apparatus executing a printing process of forming an image indicated by print data on a medium and including a liquid discharging head that includes a nozzle that discharges liquid, a pressure chamber that communicates with the nozzle, and a drive element that applies a pressure fluctuation to the liquid inside the pressure chamber, in which the printing process includes a discharging process of driving the drive element according to the print data to discharge the liquid from the liquid discharging head and making the liquid land on the medium, and a maintenance process of driving the drive element to discard the liquid inside the liquid discharging head, and the maintenance method includes: counting a unit period number, which is the number of ended unit periods among a plurality of unit periods obtained by dividing a period required for the printing process in accordance with a first condition, during the printing process; executing the maintenance process when the unit period number reaches a defined number; acquiring viscosity information related to viscosity of the liquid inside the liquid discharging head before the unit period number reaches the defined number; and decreasing the unit period number when the viscosity information satisfies a second condition.

### BRIEF DESCRIPTION OF THE DRAWINGS

FIG. 1 is a functional block view illustrating an example of a configuration of an ink jet printer 1 according to a first embodiment.

FIG. 2 is a schematic view illustrating the ink jet printer 1.

FIG. 3 is a schematic partial cross-sectional view of a recording head HD in which the recording head HD is cut so as to include a discharging portion D.

FIG. 4 is an explanatory view for describing an example of a discharging operation of ink in the discharging portion D.

FIG. 5 is an explanatory view for describing an example of a discharging operation of the ink in the discharging portion D.

FIG. 6 is an explanatory view for describing an example of a discharging operation of the ink in the discharging portion D.

FIG. 7 is a block view illustrating an example of a configuration of a liquid discharging head HU.

FIG. 8 is a view illustrating a timing chart for describing an operation of the ink jet printer 1 in a recording period Tu.

FIG. 9 is an explanatory view for describing generation of coupling state designation signals SLa[m], SLb[m], and SLa[m].

FIG. 10 is an explanatory view for describing generation of determination information Stt in a measurement circuit 9.

FIG. 11 is an explanatory view for describing a series of operations of the ink jet printer 1.

FIG. 12 is a view illustrating a flowchart showing an operation of the ink jet printer 1 during a printing process.

FIG. 13 is a view illustrating a flowchart showing the operation of the ink jet printer 1 during the printing process.

FIG. 14 is a functional block view illustrating an example of a configuration of an ink jet printer 1a according to a second embodiment.

FIG. 15 is an explanatory view for describing a series of operations of the ink jet printer 1a.

FIG. 16 is a view illustrating a flowchart showing the operation of the ink jet printer 1a during the printing process.

FIG. 17 is a view illustrating a flowchart showing the operation of the ink jet printer 1a during the printing process.

FIG. 18 is an explanatory view for describing a series of operations of an ink jet printer 1b.

FIG. 19 is a view illustrating a flowchart showing an operation of the ink jet printer 1b during the printing process.

### DESCRIPTION OF EXEMPLARY EMBODIMENTS

Hereinafter, an embodiment for carrying out the present disclosure will be described with reference to the drawings. However, in each drawing, the size and scale of each part are appropriately different from the actual ones. Further, the embodiment described below is a desired specific example of the present disclosure, so various technically desirable limitations are attached, but the scope of the present disclosure is not limited to these embodiments unless otherwise stated to limit the present disclosure in the following description.

### 1. FIRST EMBODIMENT

In the present embodiment, a liquid discharging apparatus will be described by exemplifying an ink jet printer 1 that discharges ink on a recording paper P to form an image. The ink jet printer 1 is an example of a “liquid discharging apparatus”. The ink is an example of “liquid”. The recording paper P is an example of a “medium”.

### 1.1. Overview of Ink Jet Printer 1

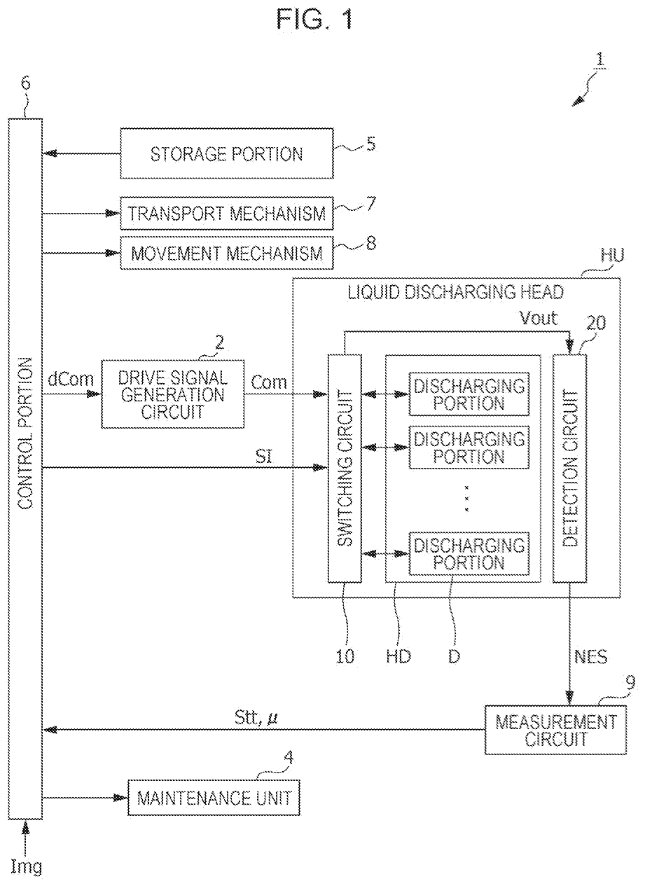

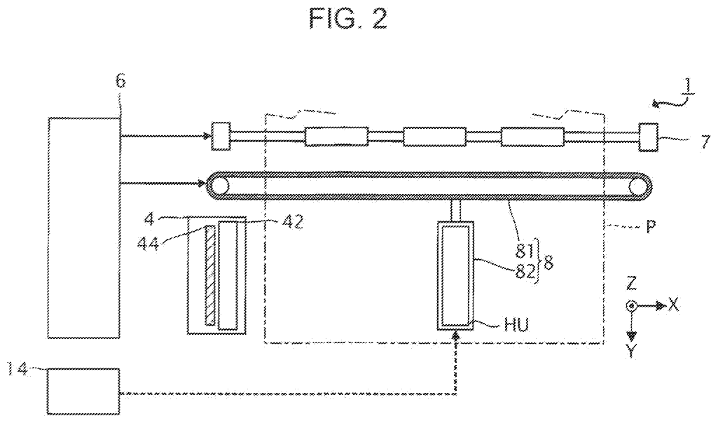

A configuration of the ink jet printer 1 according to a first embodiment will be described with reference to FIGS. 1 and 2. FIG. 1 is a functional block view illustrating an example of a configuration of an ink jet printer 1 according to a first embodiment. FIG. 2 is a schematic view illustrating the ink jet printer 1.

The ink jet printer 1 is supplied with print data Img indicating an image to be formed by the ink jet printer 1 and information indicating the number of print copies of the image to be formed by the ink jet printer 1 from a host computer such as a personal computer or a digital camera. The ink jet printer 1 executes a printing process of forming the image, which is indicated by the print data Img supplied from the host computer, on a recording paper P.

As illustrated in FIG. 1, the ink jet printer 1 includes a liquid discharging head HU provided with a discharging portion D for discharging ink, a control portion 6 that controls an operation of each portion of the ink jet printer 1, a drive signal generation circuit 2 that generates a drive signal Com for driving the discharging portion D, a storage portion 5 that stores a control program of the ink jet printer 1 and other information, a measurement circuit 9 that outputs determination information Stt indicating a result of a discharging state by determining the discharging state of the discharging portion D and viscosity information μ related to the viscosity of ink inside the discharging portion D, a transport mechanism 7 for transporting a recording paper P, a movement mechanism 8 for moving the liquid discharging head HU, and a maintenance unit 4 related to a maintenance process that executes maintenance of the discharging portion D such that the ink is discharged normally from the discharging portion D. In the following description, in order to indicate that the viscosity information μ is a specific value, the viscosity information μx may be expressed by using one or more characters x.

The viscosity information μ is an example of “a parameter corresponding to the viscosity of the liquid inside the discharging portion”, is also an example of “a parameter corresponding to the viscosity of the liquid inside the liquid discharging head”, and is also an example of “the viscosity information related to the viscosity of the liquid inside the liquid discharging head”.

In the present embodiment, the liquid discharging head HU includes a recording head HD provided with M discharging portions D, a switching circuit 10, and a detection circuit 20. In the present embodiment, M is an integer of 2 or more.

The M discharging portions D are an example of “a plurality of discharging portions”.

In the following, in order to distinguish each of the M discharging portions D provided in the recording head HD, M discharging portions D may be referred to as a first stage, a second stage, . . . , an M stage in order. Further, the m stage discharging portion D may be referred to as a discharging portion D[m]. In the following description, the variable “m” is an integer satisfying 1 or more and M or less. Further, when a component, a signal, or the like of the ink jet printer 1 corresponds to a stage number m of the discharging portion D[m], a symbol for representing the component, the signal, or the like may be represented by adding a suffix[m] indicating that the component, the signal, or the like corresponds to the stages number m.

The switching circuit 10 switches whether or not to supply the drive signal Com output from the drive signal generation circuit 2 to each discharging portion D. Further, the switching circuit 10 switches whether or not to electrically couple each discharging portion D and the detection circuit 20 each other.

For any m from 1 to M, the detection circuit 20 generates a residual vibration signal NES[m] indicating vibration remaining in the discharging portion D[m] after the discharging portion D[m] is driven based on a detection signal Vout[m] that is detected from the discharging portion D[m] driven by the drive signal Com. Hereinafter, this vibration is referred to as “residual vibration”.

For any m from 1 to M, the measurement circuit 9 generates the determination information Stt[m] indicating the result of a discharging state determination of the discharging portion D[m] and the viscosity information μ[m] based on the residual vibration signal NES[m]. In the following, the discharging portion D that is a target of the discharging state determination by the measurement circuit 9 may be referred to as a determination target discharging portion D-H. Further, a series of processes executed by the ink jet printer 1 including the discharging state determination, which is executed by the measurement circuit 9, and a preparatory process for the measurement circuit 9 to execute the discharging state determination is referred to as a discharging state determination process.

In the present embodiment, it is assumed that the ink jet printer 1 is a serial printer. Specifically, as illustrated in FIG. 2, the ink jet printer 1 executes a printing process by discharging the ink from the discharging portion D while transporting the recording paper P in a sub-scanning direction and moving the liquid discharging head HU in a main scanning direction. In the present embodiment, as illustrated in FIG. 2, the +X direction and the −X direction, which is an opposite direction of the +X direction, are the main scanning directions, and the +Y direction is the sub-scanning direction. Hereinafter, the +X direction and the −X direction are collectively referred to as the “X axis direction”, and hereinafter, the +Y direction and the −Y direction, which is an opposite direction of the +Y direction, are collectively referred to as the “Y axis direction”. Further, a direction perpendicular to the X axis direction and the Y axis direction, and which is a discharging direction of the ink is referred to as the −Z direction. The −Z direction and the +Z direction, which is an opposite direction of the −Z direction, are collectively referred to as the “Z axis direction”.

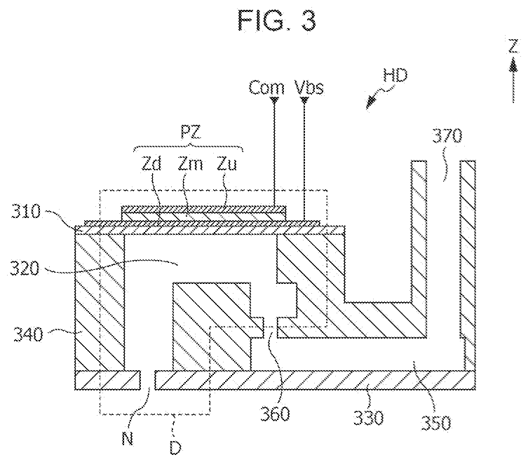

The recording head HD and the discharging portion D, which is provided on the recording head HD, will be described with reference to FIG. 3.

FIG. 3 is a schematic partial cross-sectional view of the recording head HD in which the recording head HD is cut so as to include the discharging portion D.

As illustrated in FIG. 3, the discharging portion D includes a piezoelectric element PZ, a cavity 320 filled with the ink inside, the nozzle N communicating with the cavity 320, and a vibrating plate 310. The discharging portion D discharges the ink inside the cavity 320 from the nozzle N by supplying the drive signal Com to the piezoelectric element PZ and driving the piezoelectric element PZ by the drive signal Com. The cavity 320 is a space partitioned by a cavity plate 340, a nozzle plate 330 on which the nozzle N is formed, and the vibrating plate 310. The cavity 320 communicates with a reservoir 350 via an ink supply port 360. The reservoir 350 communicates with a liquid container 14 corresponding to the discharging portion D via an ink intake port 370.

The piezoelectric element PZ is an example of a “drive element”. Further, the cavity 320 is an example of a “pressure chamber”.

In the present embodiment, a unimorph type as illustrated in FIG. 3 is used as the piezoelectric element PZ. The piezoelectric element PZ is not limited to the unimorph type, and a bimorph type, a laminated type, or the like may be used.

The piezoelectric element PZ has an upper electrode Zu, a lower electrode Zd, and a piezoelectric body Zm provided between the upper electrode Zu and the lower electrode Zd. The piezoelectric element PZ is a passive element that deforms in response to a change in potential of the drive signal Com. When a voltage is applied between the upper electrode Zu and the lower electrode Zd by electrically coupling the lower electrode Zd to a feeder line LHd, which is set to a constant potential Vbs, and supplying the drive signal Com to the upper electrode Zu, the piezoelectric element PZ is displaced in the +Z direction or the −Z direction according to the applied voltage, and as a result of the displacement, the piezoelectric element PZ vibrates.

A vibrating plate 310 is installed on an upper surface opening portion of the cavity plate 340. The lower electrode Zd is bonded to the vibrating plate 310. Therefore, when the piezoelectric element PZ is driven by the drive signal Com and vibrates, the vibrating plate 310 also vibrates. Thereafter, the volume of the cavity 320 changes due to the vibration of the vibrating plate 310, and the ink that fills the cavity 320 is discharged from the nozzle N. When the ink inside the cavity 320 decreases due to the discharge of the ink, the ink is supplied from the reservoir 350.

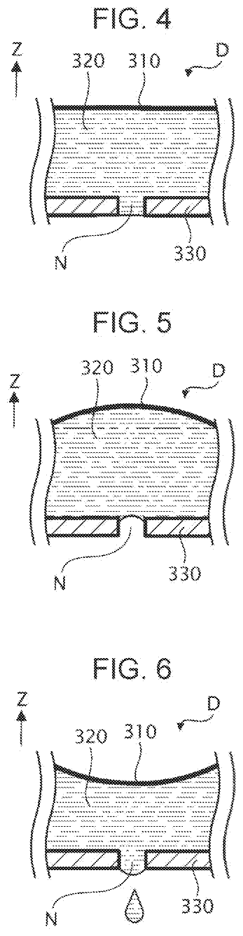

FIGS. 4 to 6 are explanatory views for describing an example of a discharging operation of the ink in the discharging portion D. As illustrated in FIG. 5, the control portion 6 generates distortion such that the piezoelectric element PZ is displaced in the +Z direction and bends the vibrating plate 310 of the discharging portion D in the +Z direction by changing the potential of the drive signal Com supplied to the piezoelectric element PZ included in the discharging portion D. As a result, as in a state illustrated in FIG. 5, the volume of the cavity 320 of the discharging portion D is expanded as compared with a state illustrated in FIG. 4.

Next, the control portion 6 generates the distortion such that the piezoelectric element PZ is displaced in the −Z direction and bends the vibrating plate 310 of the discharging portion D in the −Z direction by changing the potential of the drive signal Com. As a result, as in the state illustrated in FIG. 6, the volume of the cavity 320 rapidly contracts, and a part of the ink that fills the cavity 320 is discharged as ink droplets from the nozzle N that communicates with the cavity 320. After the piezoelectric element PZ and the vibrating plate 310 are driven by the drive signal Com and displaced in the Z axis direction, the residual vibration is generated in the discharging portion D which includes the vibrating plate 310.

The description is returned to FIGS. 1 and 2. The transport mechanism 7 transports the recording paper P in the +Y direction. Specifically, the transport mechanism 7 is provided with a transporting roller (not illustrated) whose rotation axis is parallel to the X axis direction, and a motor (not illustrated) that rotates the transporting roller under control by the control portion 6.

The movement mechanism 8 reciprocates the liquid discharging head HU along the X axis under the control of the control portion 6. As illustrated in FIG. 2, the movement mechanism 8 includes a transporting body 82 having a substantially box shape for accommodating the liquid discharging head HU, and an endless belt 81 to which the transporting body 82 is fixed.

The maintenance unit 4 includes a cap 42 for covering liquid discharging head HU so that the nozzle N of the discharging portion D is sealed, a wiper 44 for wiping off foreign matter such as paper dust attached to the vicinity of the nozzle N of the discharging portion D, a tube pump (not illustrated) for sucking the ink, air bubbles, or the like inside the discharging portion D, and a discarding ink receiving portion (not illustrated) for receiving the discharged ink when the ink inside the discharging portion D is discarded. The maintenance unit 4 is provided in an area that does not overlap with the recording paper P when viewed in the Z axis direction.

The storage portion 5 includes a volatile memory such as RAM and a non-volatile memory such as ROM, EEPROM, or PROM, and stores various information such as print data Img supplied from the host computer and a control program of the ink jet printer 1. The RAM is an abbreviation for Random Access Memory. The ROM is an abbreviation for Read Only Memory. The EEPROM is an abbreviation for Electrically Erasable Programmable Read-Only Memory. PROM is an abbreviation for Programmable ROM.

The control portion 6 includes a CPU. The CPU is an abbreviation for Central Processing Unit. However, the control portion 6 may include a programmable logic device such as an FPGA instead of the CPU. The FPGA is an abbreviation for Field Programmable Gate Array.

In the control portion 6, the CPU provided in the control portion 6 operates according to a control program stored in the storage portion 5, so that the ink jet printer 1 executes the printing process. The printing process includes one or more discharging processes and one or more maintenance processes. In the discharging process, the piezoelectric element PZ is driven based on the print data Img, the ink is discharged from the liquid discharging head HU, and the ink is landed on the recording paper P. The ink jet printer 1 repeats the discharging process one or more times to form an image corresponding to the print data Img on the recording paper P. The maintenance process is a process for maintaining the discharging state of the ink in the discharging portion D in a printable state with normal quality.

The control portion 6 generates a print signal SI for controlling the liquid discharging head HU, a waveform designation signal dCom for controlling the drive signal generation circuit 2, a signal for controlling the transport mechanism 7, and a signal for controlling the movement mechanism 8.

The waveform designation signal dCom is a digital signal that defines a waveform of the drive signal Com.

Further, the drive signal Com is an analog signal for driving the discharging portion D. The drive signal generation circuit 2 includes a DA conversion circuit and generates the drive signal Com having a waveform defined by the waveform designation signal dCom. In the present embodiment, it is assumed that the drive signal Com includes a drive signal Com-A and a drive signal Com-B.

Further, the print signal SI is a digital signal for designating the type of operation of the discharging portion D. Specifically, the print signal SI designates the type of operation of the discharging portion D by designating whether or not to supply the drive signal Com with respect to the discharging portion D. The designation of the type of operation of the discharging portion D is, for example, to designate whether or not to drive the discharging portion D, designate whether or not to discharge the ink from the discharging portion D when the discharging portion D is driven, or designate the amount of ink discharged from the discharging portion D when the discharging portion D is driven.

When the printing process is executed, the control portion 6 first stores the print data Img, which is supplied from the host computer, in the storage portion 5. Next, the control portion 6 generates various control signals such as the print signal SI, the waveform designation signal dCom, the signal for controlling the transport mechanism 7, and the signal for controlling the movement mechanism 8 based on various data such as the print data Img stored in the storage portion 5. Thereafter, the control portion 6 controls the liquid discharging head HU so that the discharging portion D is driven while controlling the transport mechanism 7 and the movement mechanism 8 so as to change a relative position of the recording paper P with respect to the liquid discharging head HU based on the various control signals and various data stored in the storage portion 5. As a result, the control portion 6 adjusts the presence/absence of the discharging of the ink from the discharging portion D, the discharging amount of ink, the discharging timing of the ink, and the like, and controls the execution of the printing process for forming an image corresponding to the print data Img on the recording paper P.

In the ink jet printer 1 according to the present embodiment executes a discharging state determination process of determining whether or not the discharging state of the ink from each discharging portion D is normal, that is whether or not a discharge abnormality occurred in each discharging portion D, based on the determination information Stt output from the measurement circuit 9.

The discharge abnormality is a state in which even when a user tries to discharge the ink from the discharging portion D by driving the discharging portion D by the drive signal Com, the ink cannot be discharged according to an aspect defined by the drive signal Com. A discharge mode of the ink defined by the drive signal Com is that the discharging portion D discharges an amount of ink defined by the waveform of the drive signal Com, and the discharging portion D discharges the ink at a discharging speed defined by the waveform of the drive signal Com. That is, a state, in which the ink cannot be discharged according to the discharge mode of the ink defined by the drive signal Com, includes a state, in which an amount of ink smaller than the discharging amount of ink defined by the drive signal Com is discharged from the discharging portion D, a state, in which an amount of ink greater than the discharging amount of ink defined by the drive signal Com is discharged from the discharging portion D, and a state, in which the ink cannot be landed at a desired landing position on the recording paper P because the ink is discharged at a speed different from the ink discharging speed defined by the drive signal Com, in addition to a state in which the ink cannot be discharged from the discharging portion D.

In the discharging state determination process, the ink jet printer 1 executes a series of processes of a first process, a second process, a third process, a fourth process, and a fifth process, which are described below. In the first process, the control portion 6 selects a determination target discharging portion D-H from among M discharging portions D provided in the liquid discharging head HU. In the second process, the control portion 6 generates the residual vibration in the determination target discharging portion D-H by driving the determination target discharging portion D-H. In the third process, the detection circuit 20 generates a residual vibration signal NES based on a detection signal Vout detected from the determination target discharging portion D-H. In the fourth process, the measurement circuit 9 performs a discharging state determination targeting the determination target discharging portion D-H based on the residual vibration signal NES and generates the determination information Stt indicating the result of the determination and the viscosity information μ. In the fifth process, the control portion 6 stores the determination information Stt and the viscosity information μ in the storage portion 5.

As described above, the ink jet printer 1 according to the present embodiment executes a maintenance process in order to maintain the discharging state of the ink in the discharging portion D in a printable state with normal quality.

In the ink jet printer 1 of the present embodiment, before the printing process, after the printing process, and during performing the printing process, the maintenance process for keeping the viscosity of the ink in the discharging portion D within an appropriate range is executed in all of the M discharging portions D. Further, the ink jet printer 1 of the present embodiment determines whether or not the discharging state of the ink from the discharging portion D is normal before the printing process and/or after the printing process and when there is a discharging portion D, which is determined that the discharging state is not normal, executes the maintenance process in accordance with the state of the discharging portion D, and recovers the discharging portion D to a normal state.

Specifically, the maintenance process is a process for returning the discharging state of the ink in the discharging portion D to a normal state by executing a process once or a plurality of times among a wiping process, a pumping process, and a flushing process. The wiping process is a process of wiping off foreign matter such as paper dust attached to the vicinity of the nozzle N of the discharging portion D with a wiper 44. The pumping process is a process of sucking the ink, air bubbles, or the like inside the discharging portion D by a tube pump. The flushing process is a process of discarding thickened ink from the discharging portion D by driving the discharging portion D and supplying the non-thickened ink inside the reservoir 350 into the discharging portion D from the ink supply port 360. As described above, the maintenance unit 4 is provided in an area that does not overlap with the recording paper P when viewed in the discharging direction, that is, in the Z axis direction. Therefore, in the flushing process, the ink inside the liquid discharging head HU is discarded to a position that does not overlap the recording paper P in the discharging direction.

The “flushing process” is an example of “the maintenance process of driving a drive element to discard the liquid inside the liquid discharging head”.

The ink jet printer 1 may be capable of executing a plurality of types of flushing processes. For example, the ink jet printer 1 may execute the first flushing process and the second flushing process, in which the unit amount of flushing is smaller than that of the first flushing process but the ink can be discharged even when the thickening of the ink progresses to the extent that it is difficult to discharge the ink in the first flushing process. Hereinafter, for the sake of brevity, the ink jet printer 1 will be described as executing one type of flushing process once or a plurality of times.

### 1.2. Configuration of Liquid Discharging Head HU

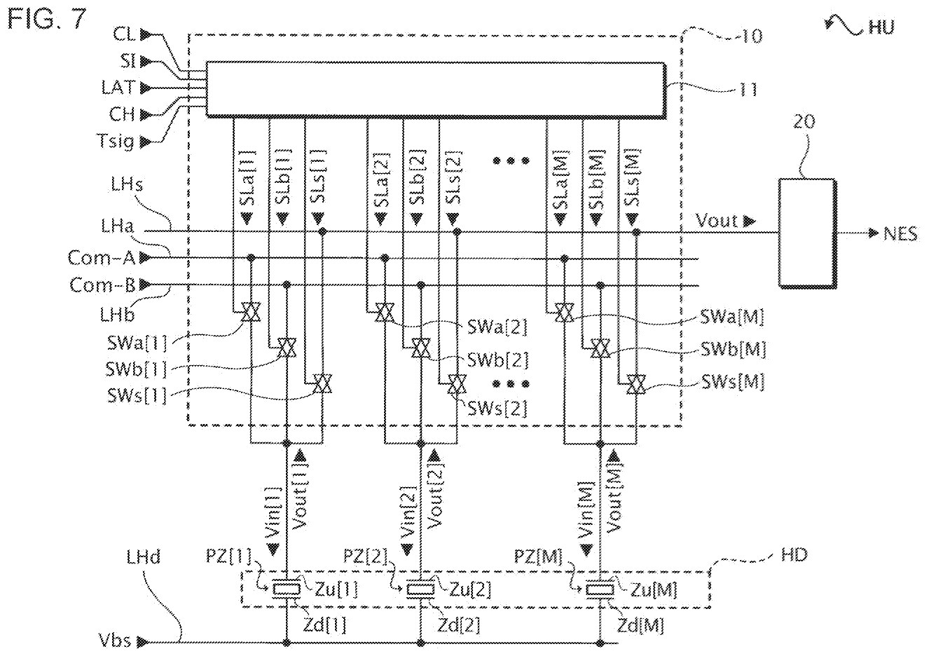

Hereinafter, a configuration of the liquid discharging head HU will be described with reference to FIG. 7.

FIG. 7 is a block view illustrating an example of the configuration of the liquid discharging head HU. As described above, the liquid discharging head HU includes the recording head HD, the switching circuit 10, and the detection circuit 20. Further, the liquid discharging head HU includes an internal wiring LHa to which the drive signal Com-A is supplied from the drive signal generation circuit 2, an internal wiring LHb to which the drive signal Com-B is supplied from the drive signal generation circuit 2, and an internal wiring LHs for supplying the detection signal Vout detected from the discharging portion D to the detection circuit 20.

As illustrated in FIG. 7, the switching circuit 10 includes M switches SWa[1] to SWa[M], M switches SWb[1] to SWb[M], M switches SWs[1] to SWs[M], and a coupling state designation circuit 11 that designates a coupling state of each switch. As each switch, for example, a transmission gate can be used.

The coupling state designation circuit 11 generates coupling state designation signals SLa[1] to SLa[M] that designate the on/off of the switches SWa[1] to SWa[M], coupling state designation signals SLb[1] to SLb[M] that designate on/off of the switches SWb[1] to SWb[M], and coupling state designation signals SLs[1] to SLs[M] that designate on/off of the switches SWs[1] to SWs[M] based on at least a part of a signal of the print signal SI, the latch signal LAT, the change signal CH, and the period designation signal Tsig supplied from the control portion 6.

For any m from 1 to M, each of the switch SWa[m] switches between conduction and non-conduction between the internal wiring LHa and the upper electrode Zu[m] of the piezoelectric element PZ[m] provided in the discharging portion D[m] according to the coupling state designation signal SLa[m]. For example, the switch SWa[m] turns on when the coupling state designation signal SLa[m] is at a high level and turns off when the coupling state designation signal SLa[m] is at a low level.

For any m from 1 to M, the switch SWb[m] switches between conduction and non-conduction between the internal wiring LHb and the upper electrode Zu[m] of the piezoelectric element PZ[m] provided in the discharging portion D[m] according to the coupling state designation signal SLb[m]. For example, the switch SWb[m] turns on when the coupling state designation signal SLb[m] is at a high level and turns off when the coupling state designation signal SLb[m] is at a low level.

For any m from 1 to M, the switch SWs[m] switches between conduction and non-conduction between the internal wiring LHs and the upper electrode Zu[m] of the piezoelectric element PZ[m] provided in the discharging portion D[m] according to the coupling state designation signal SLa[m]. For example, the switch SWs[m] turns on when the coupling state designation signal SLs[m] is at a high level and turns off when the coupling state designation signal SLs[m] is at a low level.

For any m from 1 to M, the detection circuit 20 is supplied with the detection signal Vout[m], which is output from the piezoelectric element PZ[m] of the discharging portion D[m] driven as the determination target discharging portion D-H, via the internal wiring LHs. Thereafter, the detection circuit 20 generates a residual vibration signal NES based on the detection signal Vout[m].

### 1.3. Operation of Liquid Discharging Head HU

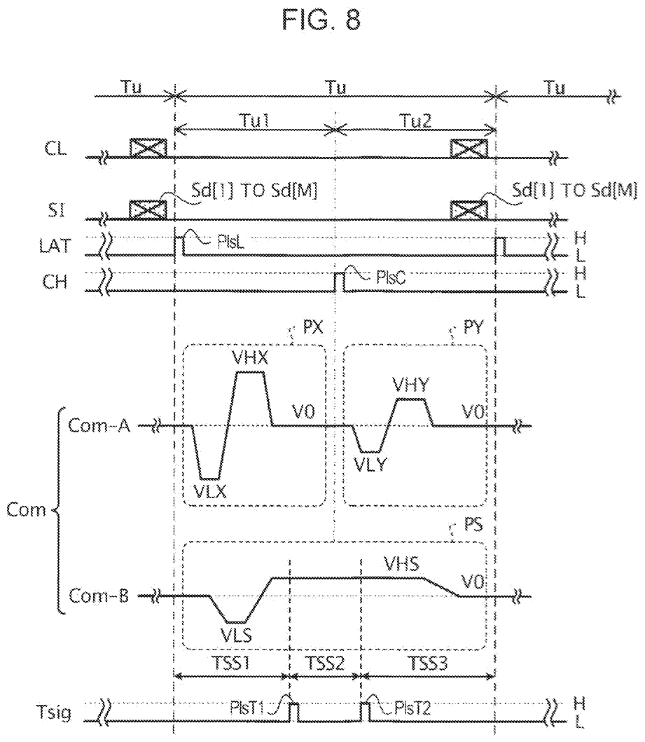

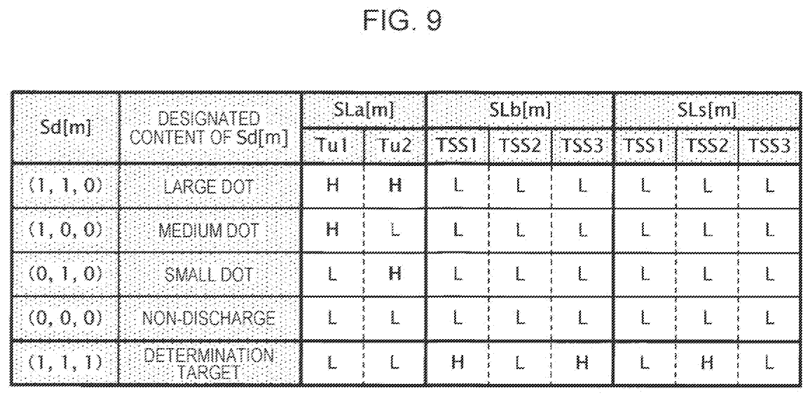

Hereinafter, an operation of the liquid discharging head HU will be described with reference to FIGS. 8 and 9.

In the present embodiment, an operating period of the ink jet printer 1 includes one or a plurality of recording periods Tu. In the ink jet printer 1 according to the present embodiment, in each recording period Tu, it is assumed to execute one of the driving of each discharging portion D in the discharging process, and the driving of the determination target discharging portion D-H in the preparatory process of the discharging state determination process and the detection of the residual vibration. However, the present disclosure is not limited to such an aspect, and in each recording period Tu, it may be possible to execute both of the driving of each discharging portion D in the discharging process, and the driving of the determination target discharging portion D-H in the preparatory process of the discharging state determination process and the detection of the residual vibration.

In general, the ink jet printer 1 forms an image indicating the print data Img by discharging the ink once or a plurality of times from each discharging portion D over a plurality of continuous or intermittent recording periods Tu. Further, in the M recording periods Tu provided continuously or intermittently, the ink jet printer 1 according to the present embodiment executes the discharging state determination process in which each of the M discharging portions D[1] to D[M] is defined as the determination target discharging portion D-H by executing the preparatory process of the discharging state determination process M times.

FIG. 8 illustrates a timing chart for describing an operation of the ink jet printer 1 in the recording period Tu.

As illustrated in FIG. 8, the control portion 6 outputs the latch signal LAT having a pulse PlsL and the change signal CH having a pulse PlsC. As a result, the control portion 6 defines the recording period Tu as a period from the rise of the pulse PlsL to the rise of the next pulse PlsL. Further, the control portion 6 divides the recording period Tu into two control periods Tu1 and Tu2 by the pulse PlsC.

The print signal SI includes individual designation signals Sd[1] to Sd[M] that designate the driving aspects of the discharging portions D[1] to D[M] in each recording period Tu. Thereafter, when at least one of the discharging process and the discharging state determination process is executed in the recording period Tu, as illustrated in FIG. 8, the control portion 6 synchronizes the print signal SI including the individual designation signals Sd[1] to Sd[M] with the clock signal CL prior to the start of the recording period Tu and supplies the print signal SI to the coupling state designation circuit 11. In this case, for any m from 1 to M, the coupling state designation circuit 11 generates coupling state designation signals SLa[m], SLb[m], and SLs[m] based on the individual designation signal Sd[m] in the recording period Tu.

For any m from 1 to M, the individual designation signal Sd[m] according to the present embodiment is a signal that designates any one of drive modes among the five drive modes of driving as the discharge of the amount of ink corresponding to a large dot, the discharge of the amount of ink corresponding to a medium dot, the discharge of the amount of ink corresponding to a small dot, the non-discharge of the ink, and the determination target in the discharging state determination process, with respect to the discharging portion D[m], in each recording period Tu. In the following description, the amount corresponding to the large dot may be referred to as a “large amount”, and the discharge of the amount of ink corresponding to the large dot may be referred to as a “formation of a large dot”. Similarly, the amount corresponding to the medium dot may be referred to as a “medium amount”, and the discharge of the amount of ink corresponding to the medium dot may be referred to as a “formation of a medium dot”. Similarly, the amount corresponding to the small dot may be referred to as a “small amount”, and the discharge of the amount of ink corresponding to the small dot may be referred to as a “formation of a small dot”. The driving as the determination target in the discharging state determination process may be referred to as a “driving as a determination target discharging portion D-H”. In the present embodiment, as an example, it is assumed that the individual designation signal Sd[m] is a 3-bit digital signal as illustrated in FIG. 9.

As illustrated in FIG. 8, the drive signal generation circuit 2 outputs the drive signal Com-A having a medium dot waveform PX provided in a control period Tu1 and a small dot waveform PY provided in a control period Tu2. In the present embodiment, the medium dot waveform PX and the small dot waveform PY are defined such that a potential difference between the maximum potential VHX and the minimum potential VLX of the medium dot waveform PX is greater than a potential difference between the maximum potential VHY and the minimum potential VLY of the small dot waveform PY. Specifically, for any m from 1 to M, when the discharging portion D[m] is driven by the drive signal Com-A having the medium dot waveform PX, the medium dot waveform PX is defined such that a medium amount of ink is discharged from the discharging portion D[m]. Further, when the discharging portion D[m] is driven by the drive signal Com-A having the small dot waveform PY, the small dot waveform PY is defined such that a small amount of ink is discharged from the discharging portion D[m]. The potentials at the start and end of the medium dot waveform PX and the small dot waveform PY are set to a reference potential VO.

Thereafter, for any m from 1 to M, when the individual designation signal Sd[m] designates the formation of the large dot with respect to the discharging portion D[m], the coupling state designation circuit 11 sets the coupling state designation signal SLa[m] to a high level in the control periods Tu1 and Tu2, and sets the coupling state designation signals SLb[m] and SLs[m] to a low level in the recording period Tu. In this case, the discharging portion D[m] is driven by the drive signal Com-A of the medium dot waveform PX in the control period Tu1 to discharge the medium amount of ink, and driven by the drive signal Com-A of the small dot waveform PY in the control period Tu2 to discharge the small amount of ink. As a result, the discharging portion D[m] discharges a large amount of ink in total in the recording period Tu, and large dots are formed on the recording paper P.

Further, when the individual designation signal Sd[m] designates the formation of the medium dot with respect to the discharging portion D[m], the coupling state designation circuit 11 sets the coupling state designation signal SLa[m] to a high level in the control period Tu1 and a low level in the control period Tu2, respectively, and sets the coupling state designation signals SLb[m] and SLs[m] to a low level in the recording period Tu. In this case, the discharging portion D[m] discharges the medium amount of ink in the recording period Tu, and medium dots are formed on the recording paper P.

Further, for any m from 1 to M, when the individual designation signal Sd[m] designates the formation of the small dot with respect to the discharging portion D[m], the coupling state designation circuit 11 sets the coupling state designation signal SLa[m] to a low level in the control period Tul and a high level in the control period Tu2, respectively, and sets the coupling state designation signals SLb[m] and SLs[m] to a low level in the recording period Tu. In this case, the discharging portion D[m] discharges the small amount of ink in the recording period Tu, and small dots are formed on the recording paper P.

Further, for any m from 1 to M, when the individual designation signal Sd[m] designates the non-discharge of the ink with respect to the discharging portion D[m], the coupling state designation circuit 11 sets the coupling state designation signals SLa[m], SLb[m], and SLs[m] to a low level in the recording period Tu. In this case, the discharging portion D[m] does not discharge the ink and does not form dots on the recording paper P in the recording period Tu.

As illustrated in FIG. 8, the drive signal generation circuit 2 outputs the drive signal Com-B having an inspection waveform PS provided in the recording period Tu. In the present embodiment, the inspection waveform PS is defined such that a potential difference between the maximum potential VHS and the minimum potential VLS of the inspection waveform PS is smaller than a potential difference between the maximum potential VHY and the minimum potential VLY of the small dot waveform PY. Specifically, for any m from 1 to M, when the discharging portion D[m] is supplied with the drive signal Com-B having the inspection waveform PS, the inspection waveform PS is defined such that the discharging portion D[m] is driven to the extent that the ink is not discharged from the discharging portion D[m]. The potential at the start and end of the inspection waveform PS is set to the reference potential V0.

Further, the control portion 6 outputs the period designation signal Tsig having the pulse PlsT1 and the pulse PlsT2. As a result, the control portion 6 divides the recording period Tu into a control period TSS1, which is from the start of the pulse PlsL to the start of the pulse PlsT1, a control period TSS2, which is from the start of the pulse PlsT1 to the start of the pulse PlsT2, and a control period TSS3, which is from the start of pulse PlsT2 to the start of the next pulse PlsL.

Further, for any m from 1 to M, when the individual designation signal Sd[m] designates the discharging portion D[m] as the determination target discharging portion D-H, the coupling state designation circuit 11 sets the coupling state designation signal SLa[m] to a low level in the recording period Tu, sets the coupling state designation signal SLb[m] to a high level in the control periods TSS1 and TSS3 and to a low level in the control period TSS2, respectively, and sets the coupling state designation signal SLs[m] to a low level in the control periods TSS1 and TSS3 and to a high level in the control period TSS2, respectively.

In this case, the determination target discharging portion D-H is driven by the drive signal Com-B of the inspection waveform PS in the control period TSS1. Specifically, the piezoelectric element PZ included in the determination target discharging portion D-H is displaced by the drive signal Com-B of the inspection waveform PS in the control period TSS1. As a result, vibration is generated in the determination target discharging portion D-H, and this vibration remains even in the control period TSS2. In the control period TSS2, the upper electrode Zu included in the piezoelectric element PZ of the determination target discharging portion D-H changes the potential according to the residual vibration generated in the determination target discharging portion D-H. In other words, in the control period TSS2, the upper electrode Zu included in the piezoelectric element PZ of the determination target discharging portion D-H indicates a potential corresponding to an electromotive force of the piezoelectric element PZ caused by the residual vibration generated in the determination target discharging portion D-H. Thereby, the potential of the upper electrode Zu can be detected as the detection signal Vout in the control period TSS2.

For any m from 1 to M, FIG. 9 is an explanatory view for describing the generation of the coupling state designation signals SLa[m], SLb[m], and SLs[m]. The coupling state designation circuit 11 generates the coupling state designation signals SLa[m], SLb[m], and SLs[m] by decoding the individual designation signal Sd[m] according to FIG. 9.

As illustrated in FIG. 9, the individual designation signal Sd[m] according to the present embodiment indicates any one of a value (1, 1, 0) that designates the formation of the large dot, a value (1, 0, 0,) that designates the formation of the medium dot, a value (0, 1, 0) that designates the formation of the small dot, a value (0, 0, 0) that designates the non-discharge of the ink, and a value (1, 1, 1) that designates the driving as the determination target discharging portion D-H. Further, the coupling state designation circuit 11 sets the coupling state designation signal SLa[m] to a high level in the control periods Tu1 and Tu2 when the individual designation signal Sd[m] indicates (1, 1, 0), sets the coupling state designation signal SLa[m] to a high level in the control period Tu1 when the individual designation signal Sd[m] indicates (1, 0, 0), sets the coupling state designation signal SLa[m] to a high level in the control period Tu2 when the individual designation signal Sd[m] indicates (0, 1, 0), sets the coupling state designation signal SLb[m] to a high level in the control periods TSS1 and TSS3 and sets the coupling state designation signal SLs[m] to a high level in the control period TSS2 when the individual designation signal Sd[m] indicates (1, 1, 1), and sets each signal to a low level when the above does not apply.

As described above, the detection circuit 20 generates the residual vibration signal NES based on the detection signal Vout. The residual vibration signal NES is a signal obtained by shaping the detection signal Vout into a waveform suitable for processing in the measurement circuit 9 by amplifying the amplitude of the detection signal Vout and removing the noise component from the detection signal Vout. The residual vibration signal NES is an analog signal.

The detection circuit 20 may be configured to include, for example, a negative feedback type amplifier for amplifying the detection signal Vout, a low-pass filter for attenuating the high frequency component of the detection signal Vout, and a voltage follower that converts impedance and outputs low impedance residual vibration signal NES.

### 1.4. Measurement Circuit 9

Next, the measurement circuit 9 will be described.

Generally, the residual vibration generated in the discharging portion D has a natural vibration frequency determined by the shape of the nozzle N, the weight of the ink that fills the cavity 320, the viscosity of the ink that fills the cavity 320, and the like.

Further, in general, when a discharge abnormality occurs in the discharging portion D because air bubbles are mixed in the cavity 320 of the discharging portion D, the frequency of the residual vibration becomes higher as compared with the case where the air bubbles are not mixed in the cavity 320. Further, in general, when a discharge abnormality occurs in the discharging portion D because foreign matter such as paper dust is attached to the vicinity of the nozzle N of the discharging portion D, the frequency of the residual vibration becomes lower as compared with the case where foreign matter is not attached. Further, in general, when the viscosity of the ink that fills the cavity 320 of the discharging portion D is high, the frequency of residual vibration becomes lower as compared with the case where the viscosity is low. Further, in general, when a discharge abnormality occurs in the discharging portion D because the ink that fills the cavity 320 of the discharging portion D is thickened, the frequency of the residual vibration becomes lower as compared with the case where foreign matter such as paper dust is attached to the vicinity of the nozzle N of the discharging portion D. Further, in general, when a discharge abnormality occurs in the discharging portion D because the cavity 320 of the discharging portion D is not filled with the ink, or when a discharge abnormality occurs in the discharging portion D because the piezoelectric element PZ fails and cannot be displaced, the amplitude of the residual vibration becomes small.

As described above, the residual vibration signal NES indicates a waveform corresponding to the residual vibration generated in the determination target discharging portion D-H. Specifically, the residual vibration signal NES indicates a frequency corresponding to the frequency of the residual vibration generated in the determination target discharging portion D-H, indicates an amplitude corresponding to the amplitude of the residual vibration generated in the determination target discharging portion D-H, and indicates an attenuation factor corresponding to an attenuation factor of the residual vibration generated in the determination target discharging portion D-H. The attenuation factor indicates the degree to which the amplitude of vibration decreases over a unit period. The measurement circuit 9 can perform detection of the determination information Stt used for the discharging state determination for determining the discharging state of the ink in the determination target discharging portion D-H based on the residual vibration signal NES. Further, the measurement circuit 9 can perform detection of the viscosity information μ of the ink in the determination target discharging portion D-H based on the residual vibration signal NES.

The viscosity information μ is a parameter indicating the characteristics of the residual vibration indicated by the residual vibration signal NES. The parameter indicating the characteristics of the residual vibration is, for example, an amplitude, a cycle, or an attenuation factor of the residual vibration. The measurement circuit 9 specifies the parameter indicating the characteristics of the residual vibration based on the residual vibration signal NES of the determination target discharging portion D-H. The measurement circuit 9 outputs the parameter indicating the characteristics of residual vibration to the control portion 6 as the viscosity information μ. As described above, the viscosity information μ in the first embodiment is a parameter corresponding to the viscosity of the ink and is information based on the residual vibration. The parameter corresponding to the viscosity of the ink is a parameter in which the viscosity of the ink can be estimated because the parameter changes according to the viscosity of the ink. For example, the parameter corresponding to the viscosity of the ink is a parameter that correlates with the viscosity of the ink. As an example, when the ink is thickened, the amplitude of the residual vibration becomes small, the frequency of the residual vibration becomes low, and the attenuation factor of the residual vibration becomes large, as described above.

The measurement circuit 9 measures the time length NTc of one cycle of the residual vibration signal NES and generates cycle information Info-T indicating the measurement result.

Further, the measurement circuit 9 generates amplitude information Info-S indicating whether or not the residual vibration signal NES has a predetermined amplitude. Specifically, in the period during which the time length NTc of one cycle of the residual vibration signal NES is being measured, the measurement circuit 9 determines whether or not the potential of the residual vibration signal NES is equal to or higher than a threshold potential Vth-O, which is a higher potential than the amplitude center level potential Vth-C of the residual vibration signal NES and is equal to or lower than the threshold potential Vth-U, which is a lower potential than the potential Vth-C. Thereafter, when the result of the determination is positive, a value indicating that the residual vibration signal NES has a predetermined amplitude, for example, “1” is set in the amplitude information Info-S, and when the result of the determination is negative, a value indicating that the residual vibration signal NES does not have the predetermined amplitude, for example, “0” is set in the amplitude information Info-S.

Thereafter, the measurement circuit 9 generates the determination information Stt indicating the determination result of the discharging state of the ink in the determination target discharging portion D-H based on the cycle information Info-T and the amplitude information Info-S.

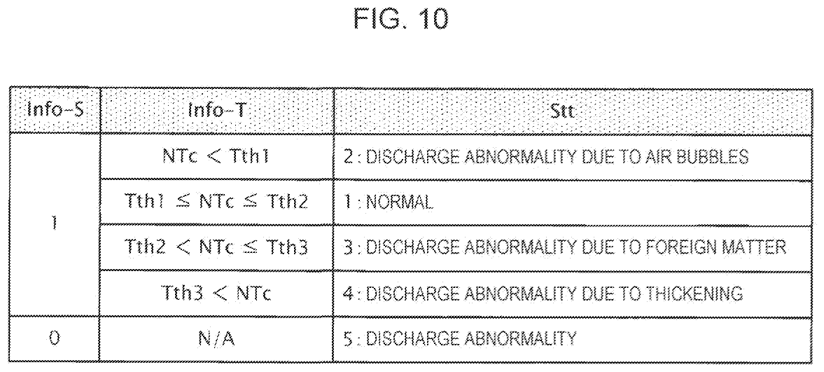

FIG. 10 is an explanatory view for describing generation of the determination information Stt in a measurement circuit 9.

As illustrated in FIG. 10, by comparing the time length NTc indicating the cycle information Info-T with a part or all of a threshold value Tthl, a threshold value Tth2, and a threshold value Tth3, the measurement circuit 9 determines the discharging state in the determination target discharging portion D-H and generates the determination information Stt indicating the result of the determination.

The threshold value Tthl is a value for indicating a boundary between the time length of one cycle of the residual vibration when the discharging state of the determination target discharging portion D-H is normal and the time length of one cycle of the residual vibration when the air bubbles are mixed in the cavity 320. Further, the threshold value Tth2 is a value for indicating a boundary between the time length of one cycle of the residual vibration when the discharging state of the determination target discharging portion D-H is normal and the time length of one cycle of the residual vibration when foreign matter is attached in the vicinity of the nozzle N. The threshold value Tth3 is a value for indicating a boundary between the time length of one cycle of the residual vibration when the foreign matter is attached in the vicinity of the nozzle N of the determination target discharging portion D-H and the time length of one cycle of the residual vibration when the ink inside the cavity 320 is thickened. The threshold values Tth1 to Tth3 satisfy “Tth1<Tth2<Tth3”.

As illustrated in FIG. 10, in the present embodiment, when the value of the amplitude information Info-S is “1” and the time length NTc indicating the cycle information Info-T satisfies “Tth1≤NTc≤Tth2”, it is considered that the discharging state of the ink in the determination target discharging portion D-H is normal. In this case, the measurement circuit 9 sets a value “1” indicating that the discharging state of the determination target discharging portion D-H is normal, to the determination information Stt.

Further, when the value of the amplitude information Info-S is “1” and the time length NTc indicating the cycle information Info-T satisfies “NTc<Tth1”, it is considered that a discharge abnormality due to air bubbles occurred in the determination target discharging portion D-H. In this case, the measurement circuit 9 sets a value “2” indicating that the discharge abnormality due to air bubbles occurred in the determination target discharging portion D-H, to the determination information Stt.

Further, when the value of the amplitude information Info-S is “1” and the time length NTc indicating the cycle information Info-T satisfies “Tth2<NTc≤Tth3”, it is considered that a discharge abnormality due to attachment of foreign matter occurred in the determination target discharging portion D-H. In this case, the measurement circuit 9 sets a value “3” indicating that the discharge abnormality due to the attachment of foreign matter occurred in the determination target discharging portion D-H, to the determination information Stt.

Further, when the value of the amplitude information Info-S is “1” and the time length NTc indicating the cycle information Info-T satisfies “Tth3<NTc”, it is considered that a discharge abnormality due to thickening occurred in the determination target discharging portion D-H. In this case, the measurement circuit 9 sets a value “4” indicating that the discharge abnormality due to the thickening occurred in the determination target discharging portion D-H, to the determination information Stt.

Further, even when the value of the amplitude information Info-S is “0”, it is considered that a discharge abnormality occurred in the determination target discharging portion D-H. In this case, the measurement circuit 9 sets a value “5” indicating that the discharge abnormality occurred in the determination target discharging portion D-H, to the determination information Stt.

Thereafter, the control portion 6 stores the determination information Stt, which is generated by the measurement circuit 9, in the storage portion 5 in association with the stage number m of the determination target discharging portion D-H corresponding to the determination information Stt. As a result, the control portion 6 manages the determination information Stt[1] to Stt[M] corresponding to the discharging portions D[1] to D[M].

As described above, when a discharge abnormality occurs in the discharging portion D because the ink that fills the cavity 320 of the discharging portion D is thickened, the frequency of the residual vibration becomes lower as compared with the case where foreign matter such as paper dust is attached to the vicinity of the nozzle N of the discharging portion D. Further, as the thickening progresses, the degree to which the magnitude of the amplitude of the residual vibration reduced with the lapse of the period increases.

The ink jet printer 1 executes the maintenance process for returning the discharging state of the ink inside the discharging portion D to a normal state by executing one or a plurality of the above-described wiping process, pumping process, and flushing process according to the determination information Stt[1] to Stt[M] corresponding to the discharging portions D[1] to D[M].

### 1.5. Execution Timing of Flushing Process

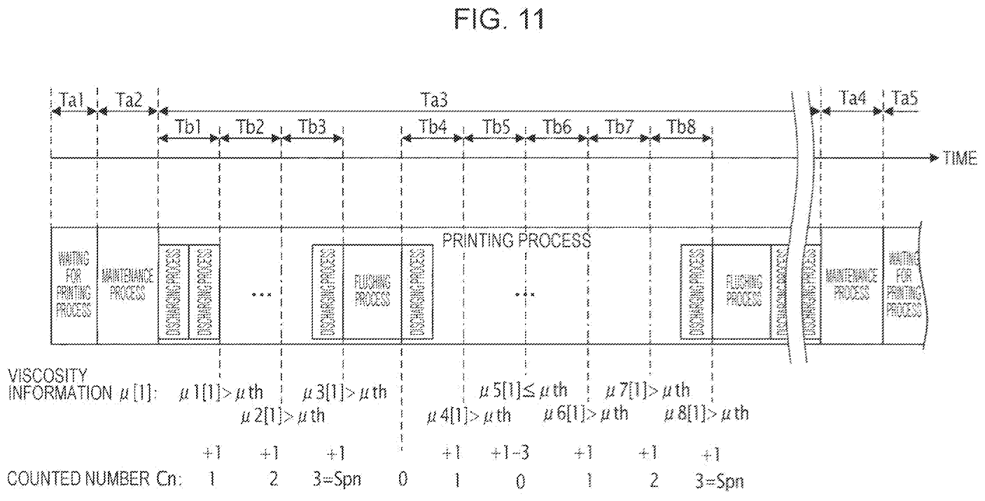

Next, the execution timing of the flushing process will be described with reference to FIG. 11.

FIG. 11 is an explanatory view for describing a series of operations of the ink jet printer 1. When the power is turned on in response to a user's operation, the ink jet printer 1 waits for the supply of the print data Img. When the print data Img is supplied during the period Tal illustrated in FIG. 11, which is a period waiting for the printing process, the period Tal is ended, and the ink jet printer 1 executes the maintenance process before the printing process. In the period Ta2 in which the maintenance process before the printing process is executed, the ink jet printer 1 releases the sealing of the nozzle N by the cap 42 and executes the flushing process.

When the maintenance process before the printing process is ended, in other words, when the period Ta2 illustrated in FIG. 11 is ended, the ink jet printer 1 executes the printing process of forming the image indicated by the print data Img supplied from the host computer on the recording paper P in a period Ta3.

During the printing process, the ink jet printer 1 executes the flushing process at a timing according to the thickening state of the ink in order to prevent the ink jet printer 1 from causing a discharging failure due to thickening of the ink between a plurality of discharging processes and from causing image quality deterioration due to thickening of the ink. In other words, in the present embodiment, the period between the plurality of maintenance processes performed during the printing process is changed according to the thickening state of the ink inside the discharging portions D[1] to D[M].

Specifically, in the first embodiment, the ink jet printer 1 counts the number of ended unit periods Tb among a plurality of unit periods Tb obtained by dividing the period Ta3 required for the printing process in accordance with a division condition. In the following, in order to distinguish each of the plurality of unit periods Tb, a number or an alphabet may be described after “Tb” such as a unit period Tb1, a unit period Tb2, a unit period Tb3, and the like. The lengths of the plurality of unit periods Tb may be the same or different from each other. However it is preferable that the lengths of the plurality of unit periods Tb are close to the same. Further, the number of counted unit periods Tb is referred to as a “counted number Cn”. It can be said that a value of the counted number Cn is a value estimated the thickening state of the ink in the discharging portion D. The counted number Cn is an integer of 0 or more. When the counted number Cn reaches a defined number Spn set in advance, in other words, when it is estimated that the ink inside the discharging portion D has thickened to the extent that the flushing process is required, the ink jet printer 1 performs the flushing process on the discharging portion D.

The division condition for dividing the period Ta3 required for the printing process is an example of a “first condition”. The counted number Cn is an example of a “unit period number”.

The division condition for dividing the period Ta3 required for the printing process has, for example, the following three aspects. The division condition in a first aspect is that when an image is formed on a predetermined number of sheets of recording paper P, it is determined that one unit period Tb is ended. The division condition in a second aspect is that when the liquid discharging head HU repeats moving from one end to the other end in the X axis direction and returning to the one end a predetermined number of times, it is determined that one unit period Tb is ended. The division condition in a third aspect is that when a predetermined period is ended, it is determined that one unit period Tb is ended. The predetermined period is, for example, a period that is an integral multiple of the recording period Tu, which is one cycle of the drive signal Com illustrated in FIG. 8.

As described above, it can be said that the counted number Cn is a value estimated the thickening state of the ink in the discharging portion D. Generally, the solvent of the ink inside the discharging portion D[m] evaporates due to the change with time, and the ink inside the discharging portion D[m] becomes thickened. Therefore, the number of ended unit periods Tb corresponds to the progress of thickening of the ink in the discharging portion D[m]. Therefore, the ink jet printer 1 increases the counted number Cn each time the unit period Tb is ended, assuming that the ink has never been discharged from the nozzle N of in the discharging portion D[m] within the unit period Tb.

On the other hand, when the ink is discharged from the nozzle N[m], since the thickened ink inside the discharging portion D[m] is discharged, and the ink inside the reservoir 350 is supplied from the ink supply port 360 into the discharging portion D[m], the viscosity of the ink inside the discharging portion D[m] decreases. When it is determined that a counted number decrease condition, which is estimated that the viscosity of the ink inside the discharging portion D is decreased to a predetermined viscosity state due to the discharging process, is satisfied, the ink jet printer 1 decreases the counted number Cn.

In the present embodiment, the ink jet printer 1 measures the viscosity information μ[1] to μ[M] of the discharging portions D[1] to D[M] at a predetermined timing within the period Ta3 required for the printing process, and decreases the counted number Cn when it is determined that all of the viscosity information μ[1] to μ[M] are equal to or less than a predetermined threshold value μth and the counted number decrease condition is satisfied. That is, the counted number decrease condition in this embodiment is that the viscosity information μ[1] to μ[M] are equal to or less than the predetermined threshold value μth. The threshold value μth and the value for decreasing the counted number Cn when the counted number decrease condition is satisfied are determined in advance by a manufacturer or a user of the ink jet printer 1. Any values may be used as the threshold value μth and the value for decreasing the counted number Cn when the and the counted number decrease condition is satisfied. However, the value for decreasing the counted number Cn when the counted number decrease condition is satisfied is set to a value corresponding to the threshold value μth. For example, in the first embodiment, the threshold value μth is defined as the viscosity that does not require the flushing process, which corresponds to a state in which the ink is not thickened, that is, a state of the viscosity immediately after the flushing process, and the value for decreasing the counted number is determined to be equal to or greater than the defined number Spn. Since the counted number Cn is an integer of 0 or more, when the counted number Cn becomes less than 0 as a result of decreasing the counted number Cn, the ink jet printer 1 sets the counted number Cn to 0. In the first embodiment, when all of the viscosity information μ[1] to the viscosity information μ[M] are equal to or less than the threshold value μth, the value equal to or greater than the defined number Spn is decreased from the counted number Cn. As a result, when all of the viscosity information μ[1] to the viscosity information μ[M] are equal to or less than the threshold value μth, since the ink inside the discharging portion D[1] to the discharging portion D[M] is a state in which the ink is not thickened, the counted number Cn is set to “0” as in the case immediately after the flushing process.

The counted number decrease condition is an example of a “second condition”.

Further, when the flushing process is executed with respect to the discharging portion D[1] to the discharging portion D[M], the counted number Cn is reset, that is, set to 0.

Next, the counting of the counted number Cn will be described more specifically. The ink jet printer 1 increases the counted number Cn each time the unit period Tb is ended, measures the viscosity information μ[1] to μ[M] of the discharging portions D[1] to D[M] before determining that the counted number Cn reaches the defined number Spn, and decreases the counted number Cn when the measured viscosity information μ[1] to μ[M] are equal to or less than the threshold value μth. The timing for measuring the viscosity information μ[1] to μ[M] may be any timing before it is determined that the counted number Cn reaches the defined number Spn, and the number of times the viscosity information μ[1] to μ[M] are measured may be many times. For example, the ink jet printer 1 may measure the viscosity information μ[1] to μ[M] when the counted number Cn reaches a value obtained by subtracting the predetermined number from the defined number Spn. In the first embodiment, the ink jet printer 1 measures the viscosity information μ[1] to μ[M] when the counted number Cn is added by 1, in other words, each time one unit period Tb is ended.

When it is determined that the counted number Cn reaches the defined number Spn, the ink jet printer 1 executes the flushing process with respect to the discharging portions D[1] to D[M]. The defined number Spn is a value determined in advance by the manufacturer or the user of the ink jet printer 1. For example, the manufacturer of the ink jet printer 1 determines a value obtained by dividing the period, which is from a state in which the ink is not thickened to a state immediately before the ink is thickened and the discharging failure occurs without discharging any ink, by the length of one unit period Tb, as the defined number Spn. In other words, no ink is discharged from the discharging portion D[m] until immediately before the last discharging process within the last unit period Tb of the number of unit periods Tb corresponding to the defined number Spn, and no discharging failure occurs when the ink is discharged from the discharging portion D in the last discharging process. In a continuous unit period Tb with a number greater than the defined number Spn, when the discharging process is continued without executing the maintenance process, no ink is discharged from the discharging portion D[m] in the unit period Tb corresponding to the defined number of Spn, and when the ink is discharged from the discharging portion D[m] in the discharging process in the next unit period Tb, there is a possibility that discharging failure occurs. That is, the defined number Spn corresponds to a period during which stable ink discharging can be guaranteed from the discharging portion D regardless of a status of the discharging of the ink in the discharging portion D.

The determined defined number Spn is stored in the storage portion 5.

FIG. 11 illustrates an example of printing process in which the defined number Spn is 3. Further, in FIG. 11, the viscosity information μ[1] in the discharging portion D[1] and the counted number Cn are illustrated at the end of each of the unit period Tb1, the unit period Tb2, the unit period Tb3, the unit period Tb4, the unit period Tb5, the unit period Tb6, and the unit period Tb7. Further, it is premised that all of the viscosity information μ5[1] to the viscosity information μ5[M] measured at the end of the unit period Tb5 are equal to or less than the threshold value μth, and the counted number decrease condition is satisfied. Furthermore, it is premised that all the viscosity information μ1[1], μ2[1], μ3[1], μ4[1], μ6[1], μ7[1] measured at the end of each of the unit periods Tb1, Tb2, Tb3, Tb4, Tb6, and Tb7 are greater than the threshold value μth, and the counted number decrease condition is not satisfied. The threshold value μth is determined to be a value corresponding to the viscosity state immediately after the flushing process, and the value for decreasing the counted number when the counted number decrease condition is satisfied is determined to be 3, which is the same number as the defined number Spn.

The ink jet printer 1 increases the counted number Cn by 1 at the end of each of the unit period Tb1, the unit period Tb2, and the unit period Tb3. However, since at least the viscosity information μ[1] is a value exceeding the threshold value μth, the counted number decrease condition is not satisfied and the counted number Cn is not decreased. At the end of the unit period Tb3, since the counted number Cn reaches 3, which is the defined number Spn, the ink jet printer 1 executes the flushing process with respect to the discharging portion D[1] to the discharging portion D[M]. When the flushing process is executed, the counted number Cn is reset. Subsequently, the ink jet printer 1 increases the counted number Cn by 1 at the end of each of the unit period Tb4 and the unit period Tb5, but does not reduce the counted number Cn. At the end of the unit period Tb5, since all of the viscosity information μ5[1] to μ5[M] are equal to or less than the threshold value μth and the counted number decrease condition is satisfied, the ink jet printer 1 sets the counted number Cn to 0 as a result of increasing the counted number Cn by 1 while decreasing the counted number Cn by 3. Subsequently, the ink jet printer 1 increases the counted number Cn by 1 at the end of each of the unit period Tb6, the unit period Tb7, and the unit period Tb8, but does not reduce the counted number Cn. At the end of the unit period Tb8, since the counted number Cn reaches 3, which is the defined number Spn, the ink jet printer 1 executes the flushing process with respect to the discharging portions D[1] to D[M].

When the printing process is ended, that is when the period Ta3 is ended in the example of FIG. 11 and in the period Ta4 in the example of FIG. 11, the maintenance process after the printing process is executed. In the maintenance process after the execution of the printing process is ended, the ink jet printer 1 executes the flushing process.

### 1.6. Operation During Printing Process

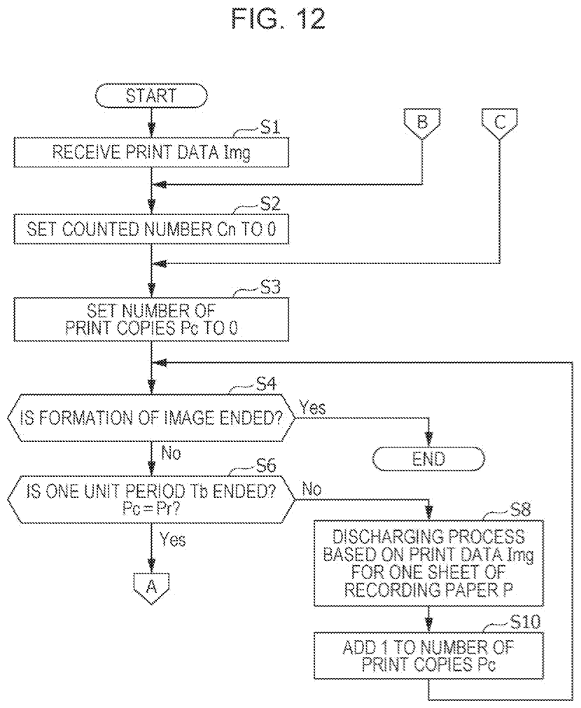

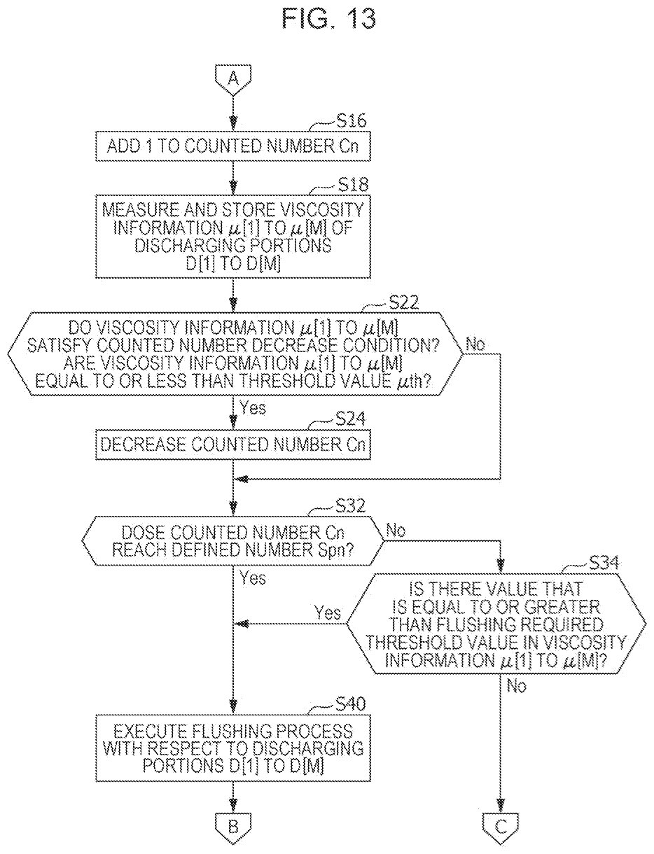

A more detailed operation of the ink jet printer 1 during the printing process will be described with reference to FIGS. 12 and 13. FIGS. 12 and 13 are flowcharts showing the operation of the ink jet printer 1 during the printing process. In step S1, the control portion 6 receives the print data Img from a host computer. Next, in step S2, the control portion 6 sets the counted number Cn to 0.

Further, in the next step S3, the control portion 6 sets a count for measuring one unit period Tb to 0. As the division condition for dividing the period Ta3 required for the printing process of the present flowchart, the division condition of the first aspect for determining that one unit period Tb is ended is adopted when an image is formed on Pr sheets of the recording paper P. Therefore, in step S3, the control portion 6 sets the number of print copies Pc, which is the number of print copies of the recording paper P, to 0.

When the division condition for dividing the period Ta3 required for the printing process is set to the second aspect, in step S3, the control portion 6 can set a passed number Pc′, which is the number of times of executing the printing on the recording paper P accompanying one movement of the liquid discharging head HU in the X axis direction, to 0. Further, when the division condition for dividing the period Ta3 required for the printing process is set to the third aspect, in step S3, the control portion 6 sets the counted number Pc″ for measuring the predetermined period to 0.

Next, in step S4, the control portion 6 determines whether or not the formation of the image on the recording paper P is ended. For example, when all the dots constituting the image indicated by the print data Img are formed on the recording paper P, or when the user instructs to stop the execution of the printing process, the control portion 6 determines that the formation of the image on the recording paper P is ended, determines that the determination result in step S4 is positive, and ends the printing process.

When the determination result in step S4 is negative, that is, when the image formation is not ended yet, in step S6, the control portion 6 determines whether or not one unit period Tb is ended. In the present flowchart, since the division condition for dividing the period Ta3 required for the printing process is set to the first aspect, it is determined whether or not the number of print copies Pc reaches the Pr sheets of the recording paper P corresponding to one unit period Tb. In the present embodiment, it is assumed that Pr is set to “1”. That is, one unit period Tb corresponds to a period for forming an image on one sheet of the recording paper P. When the division condition for dividing the period Ta3 required for the printing process is set to the second aspect, in step S6, the control portion 6 can determine whether or not printing on the recording paper P accompanying one movement of the liquid discharging head HU in the X axis direction is executed for Pr′ times corresponding to one unit period Tb. Further, when the division condition for dividing the period Ta3 required for the printing process is set to the third aspect, in step S6, the control portion 6 can determine whether or not the counted number for measuring the predetermined period reaches the counted number Pr″ corresponding to one unit period Tb.

When the determination result in step S6 is negative, that is, when one unit period Tb is not ended, in step S8, the control portion 6 executes printing on the recording paper P based on the print data Img. In the present flowchart, since the division condition for dividing the period Ta3 required for the printing process is the first aspect, when the number of print copies Pc of the recording paper P does not reach the number of print copies Pr corresponding to one unit period Tb and it is determined that the determination result in step S6 is negative, in step S8, the control portion 6 executes printing for one sheet of recording paper P based on the print data Img. When the division condition for dividing the period Ta3 required for the printing process is set to the second aspect, and when the number of movements of the liquid discharging head HU in the X axis direction does not reach the number of times Pr′ corresponding to one unit period Tb and it is determined that the determination result in step S6 is negative, in step S8, the control portion 6 can execute printing on the recording paper P accompanying the movement of the liquid discharging head HU in the X axis direction based on the print data Img. Further, when the division condition for dividing the period Ta3 required for the printing process is set to the third aspect, and when the counted number for measuring the predetermined period does not reach the counted number Pr″ corresponding to one unit period Tb and it is determined that the determination result in step S6 is negative, in step S8, the control portion 6 can execute printing on the recording paper P by the predetermined times of discharging process based on the print data Img. Although not illustrated in FIG. 12, in step S8, the liquid discharging head HU receives a print signal SI generated by the control portion 6 based on the print data Img for each recording period Tu, and each of the discharging portions D[1] to D[M] of the liquid discharging head HU executes an operation of discharging the ink or not discharging the ink based on the received print signal SI as the discharging process.

Next, in step S10, the control portion 6 executes a process for measuring one unit period Tb according to the execution of printing on the recording paper P in step S8. In the present flowchart, since the division condition for dividing the period Ta3 required for the printing process is set to the first aspect, the control portion 6 adds 1 to the number of print copies Pc of the recording paper P. When the division condition for dividing the period Ta3 required for the printing process is set to the second aspect, it is possible to add a number corresponding to the number of movements of the liquid discharging head HU in the X axis direction executed in step S8 to the passed number Pc′, which is the number of times of executing the printing on the recording paper P accompanying one movement of the liquid discharging head HU in the X axis direction. Further, when the division condition for dividing the period Ta3 required for the printing process is set to the third aspect, it is possible to add the counted number corresponding to the printing executed in step S8 to the counted number Pc″ for measuring the predetermined period. After the process in step S10 is ended, the ink jet printer 1 returns the process to step S4.

When the determination result in step S6 is positive, that is, when one unit period Tb is ended, the control portion 6 adds one to the counted number Cn in step S16. Next, in step S18, the ink jet printer 1 measures the viscosity information μ[1] to μ[M] of the discharging portions D[1] to D[M] and stores the viscosity information μ[1] to μ[M] in the storage portion 5. More specifically, the control portion 6 selects a discharging portion D[m] from the discharging portions D[1] to D[M] as a determination target discharging portion D-H, acquires viscosity information μ[m] from the measurement circuit 9, and stores the viscosity information μ[m] in the storage portion 5. This process is executed for each of the discharging portion D[1] to the discharging portion D[M].

After the process in step S18 is ended, the control portion 6 determines in step S22 whether or not the viscosity information μ[1] to μ[M] satisfy the counted number decrease condition. When the viscosity information μ[1] to μ[M] satisfy the counted number decrease condition and the determination result in step S22 is positive, the process proceeds to step S24, the control portion 6 decreases the counted number Cn and advances the process to step S32. In the present embodiment, in step S24, the counted number Cn is set to “0” by decreasing 3, which is the same as the defined number Spn, from the counted number Cn. In the example of FIG. 11, at the end of the unit period Tb5, the control portion 6 determines that all of the viscosity information μ5[1] to the viscosity information μ5[M] are equal to or less than the threshold value μth and the determination result in step S22 is positive. On the other hand, at the end of each of the unit periods Tb1, Tb2, Tb3, Tb4, Tb6, and Tb7, the control portion 6 determines that the determination result in step S22 is negative because at least the viscosity information μ[1] of the discharging portion D[1] is greater than the threshold value μth. In step S22, when any of the values in the viscosity information μ[1] to the viscosity information μ[M] exceeds the threshold value μth and the determination result is negative, the control portion 6 advances the process to step S32.

In step S32, the control portion 6 determines whether or not the counted number Cn reaches the defined number Spn. When the counted number Cn reaches the defined number Spn and the determination result in step S32 is positive, in step S40, the ink jet printer 1 executes the flushing process with respect to the discharging portions D[1] to D[M]. After the process in step S40 is ended, the control portion 6 returns the process to step S2 and resets the counted number Cn.

On the other hand, in step S32, when the counted number Cn does not reach the defined number Spn and the determination result is negative, the ink jet printer 1 advances the process to step S34. In the process of step S34, the control portion 6 determines whether or not there is a value equal to or greater than a flushing required threshold value in the viscosity information μ[1] to μ[M]. The flushing required threshold value is the viscosity at which the flushing process is required, and specifically, is the viscosity at which the discharging failure of the ink may occur while the next unit period Tb elapses. The flushing required threshold value is determined in advance by the manufacturer or the user of the ink jet printer 1. For example, the manufacturer of the ink jet printer 1 determines, as the flushing required threshold value, the viscosity at which the discharging failure of the ink may occur depending on the status of the discharging of the ink in the discharging portion D while the next unit period Tb elapses. In other words, when the viscosity information μ is equal to or less than the flushing required threshold value, stable discharging of the ink from the discharging portion D is guaranteed regardless of the status of the discharging of the ink in the discharging portion D for at least the next unit period Tb.

The flushing required threshold value is an example of “the viscosity requiring the maintenance process”.

When there is a value equal to or greater than the flushing required threshold value in the viscosity information μ[1] to μ[M] and the determination result in step S34 is positive, in step S40, the ink jet printer 1 executes the flushing process with respect to the discharging portions D[1] to D[M]. After the process in step S40 is ended, the control portion 6 returns the process to step S2 and resets the counted number Cn. On the other hand, when there is no value equal to or greater than the flushing required threshold value in the viscosity information μ[1] to μ[M] and the determination result in step S34 is negative, the ink jet printer 1 returns the process to step S3 and resets the count for measuring one unit period Tb while the counted number Cn is being counted.

### 1.7. Round-up of First Embodiment

As described above, the ink jet printer 1 includes a nozzle N that discharges the ink, a cavity 320 that communicates with the nozzle N, and the liquid discharging head HU including a piezoelectric element PZ that applies pressure fluctuations to the ink inside the cavity 320 and executes the printing process of forming an image indicated by the print data Img on the recording paper P. The printing process includes the discharging process of driving the piezoelectric element PZ according to the print data Img to discharge the ink from the liquid discharging head HU and landing the ink on the recording paper P and the flushing process of driving the piezoelectric element PZ to discard the ink that is inside the liquid discharging head HU. The ink jet printer 1 adds the number of ended unit periods Tb, among a plurality of unit periods Tb obtained by dividing the period required for the printing process in accordance with the division condition, to the counted number Cn in the printing process, executes the maintenance process with respect to the discharging portion D when the counted number Cn reaches the defined number Spn, acquires the viscosity information μ related to the viscosity of the ink inside the liquid discharging head HU before the counted number Cn reaches the defined number Spn, and executes a maintenance method of decreasing the counted number Cn when the viscosity information μ satisfies the counted number decrease condition.

The ink discarded by the flushing process is ink that does not form the dots constituting an image, and excessive discharging is a waste of ink. For example, in an aspect in which the flushing process is periodically executed at regular periods, even in a case where the thickening of the ink inside the liquid discharging head HU is eliminated by printing an image on the recording paper P with a high duty, which has a high ratio of discharging process in which the ink is discharged from the discharging portion D of the plurality of discharging processes included in the unit period Tb, when the timing is periodical, the flushing process is forcibly executed, which causes waste of ink. Further, the unnecessary flushing process not only wastes ink, but also reduces the number of print copies per unit period, that is, leads to a decrease in throughput.

On the other hand, in the present embodiment, the counted number Cn, which can be said to be the value estimated for the thickening state of the discharging portion D, is increased according to the ended unit period Tb, and the timing to execute the flushing process is adjusted by decreasing the counted number Cn when the counted number decrease condition is satisfied. Therefore, the ink jet printer 1 in the present embodiment can reduce the number of times of executing the flushing process in a state in which the discharging failure of the ink does not occur, that is, while ensuring good printing quality as compared with the aspect in which the flushing process is executed periodically at regular periods. By reducing the number of times of executing the flushing process, it is possible to reduce the waste of ink and improve the throughput.

Further, the viscosity information μ is a parameter corresponding to the viscosity of the ink inside the discharging portion D of each of the M discharging portions D. The measurement circuit 9 measures the viscosity information μ[1] to μ[M] corresponding to each of the discharging portions D[1] to D[M] for any m from 1 to M each time one unit period Tb included in the plurality of unit periods Tb is ended. When the measured viscosity information μ[1] to μ[M] satisfy the counted number decrease condition, the control portion 6 decreases the counted number Cn.

When the viscosity information μ[1] to μ[M] satisfy the counted number decrease condition, it indicates that the thickening of the ink inside the discharging portions D[1] to D[M] is eliminated. Therefore, when the viscosity information μ[1] to μ[M] satisfy the counted number decrease condition, the counted number Cn is decreased, so that the counted number Cn can accurately indicate the thickening state of the ink inside the discharging portions D[1] to D[M]. Since the counted number Cn accurately indicates the thickening state of the ink, even though the thickening of the ink inside the discharging portion D has not progressed to the extent that the flushing process is required, it is possible to prevent the flushing process from being executed.

Further, since the discharging portion D[1] to the discharging portion D[M] are arranged in one plane of the liquid discharging head HU, the thickening degree may differ between the discharging portion D positioned at the end portion of an array group and the discharging portion D positioned at the central portion of the array group. Further, in a plurality of discharging portions D, the thickening degree may differ because of the manufacturing variations of the flow path and the like. In particular, in the discharging process, since the discharging according to the print data Img is performed on the discharging portion D[1] to the discharging portion D[M], the status of the discharging of the nozzle N in each discharging portion D is different, and the state of the flow of the ink in each discharging portion D is different. Further, since the influence of the wind generated by the relative movement between the liquid discharging head HU and the recording paper P in the printing process and the influence of the environmental state around the liquid discharging head HU differ depending on the position of the discharging portion D, the thickening degree of the discharging portion D[1] to the discharging portion D[M] after the execution of the printing process varies. In the first embodiment, since it is determined whether or not the viscosity information μ[1] to μ[M] measured in each of the M discharging portions D satisfies the counted number decrease condition, it is possible to appropriately eliminate the thickening of the ink inside the discharging portion D in each of the plurality of discharging portions D.

Further, the liquid discharging head HU includes M discharging portions D having a nozzle N, a cavity 320, and a piezoelectric element PZ. When all the viscosity information μ of the discharging portions D of the M discharging portions D are equal to or lower than the viscosity that does not require the maintenance process, the control portion 6 resets the counted number Cn, that is, sets the counted number Cn to 0.

The ink jet printer 1 can manage an execution timing of the flushing process by using a common counted number Cn with respect to the M discharging portions D and reduce the number of times of executing the flushing process while maintaining a state in which the discharging failure of the ink does not occur with a simple process by resetting the case where all the viscosity information μ of the M discharging portions D are equal to or less than the viscosity that does not require the flushing process corresponding to the viscosity state immediately after the flushing process.

Further, among the viscosity information μ of the discharging portion D of each of the M discharging portions D, when there is viscosity information μ that is equal to or greater than the flushing required threshold value, the ink jet printer 1 executes the flushing process with respect to the discharging portion D.

When there is at least one discharging portion D having viscosity information μ which is equal to or greater than the flushing required threshold value among the M discharging portions D, by executing the flushing process the ink jet printer 1 can reduce the occurrence of the discharging failure of the ink.

However, the target for executing the flushing process is not limited to all of the M discharging portions D. For example, when there is viscosity information μ that is equal to or greater than the flushing required threshold value, the ink jet printer 1 may execute the flushing process only on the discharging portion D corresponding to the viscosity information μ that is equal to or greater than the flushing required threshold value. However, in that case, the reset of the counted number Cn is not executed.

### 2. SECOND EMBODIMENT

The viscosity information μ related to the viscosity of the ink in the first embodiment is a parameter indicating the characteristics of the residual vibration indicated by the residual vibration signal NES, but the viscosity information μ is not limited to this. The viscosity information μ in a second embodiment is different from the first embodiment in that the viscosity information μ is a discharging amount which is the amount of ink discharged from the discharging portion D[m] within one unit period Tb.

Further, the counted number decrease condition in the first embodiment is that the viscosity information μ is equal to or less than the threshold value μth, but the counted number decrease condition is not limited to this. The counted number decrease condition in the second embodiment is different from the first embodiment in that the discharging amount of the discharging portion D in one unit period Tb is equal to or greater than the threshold value.

Further, the counted number Cn in the first embodiment is different from the first embodiment in that the counted number Cn is counted as the common counted number Cn with respect to the discharging portions D[1] to D[M], but in the second embodiment, the counted number Cn is counted as the counted number Cn[1] to Cn[M] for each of the discharging portions D[1] to D[M].

Hereinafter, the second embodiment will be described.

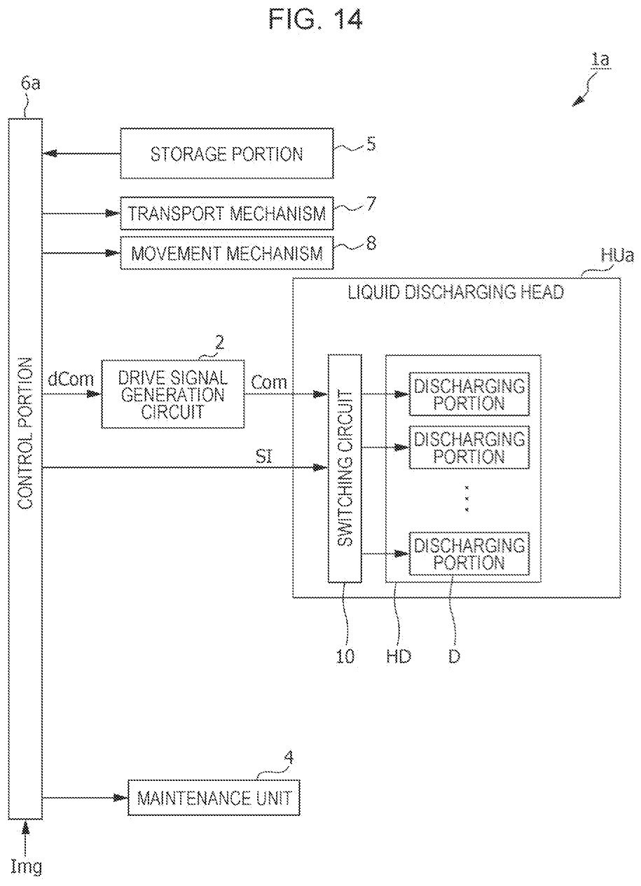

FIG. 14 is a functional block view illustrating an example of a configuration of an ink jet printer 1a according to a second embodiment. The ink jet printer 1a differs from the ink jet printer 1 in that a control portion 6a is included instead of the control portion 6, a liquid discharging head HUa is included instead of the liquid discharging head HU, and the measurement circuit 9 is not included. Although FIG. 14 illustrates a configuration in which the ink jet printer 1a does not include the measurement circuit 9 and the detection circuit 20, the ink jet printer 1a is configured to include the measurement circuit 9 and the detection circuit 20 in order to detect the discharge abnormality of the discharging portion D.

### 2.1. Execution Timing of Flushing Process in Second Embodiment

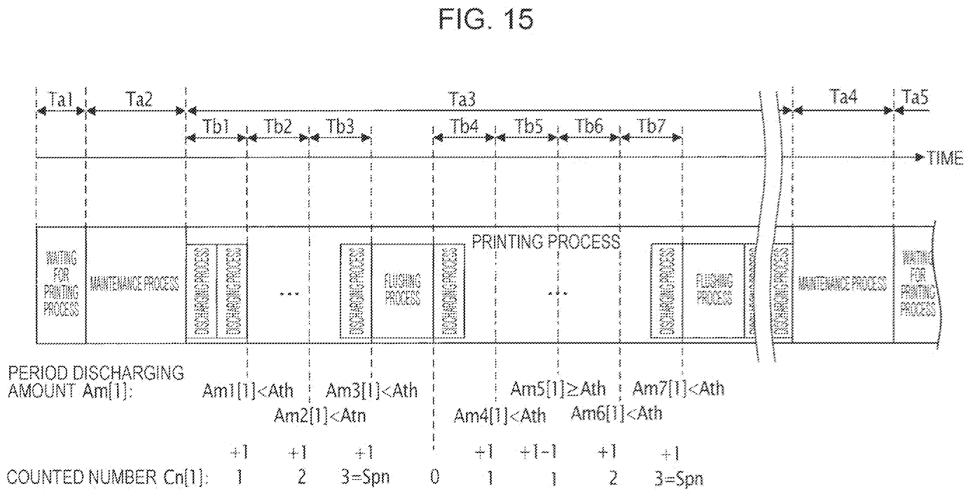

Next, the execution timing of the flushing process in the second embodiment will be described with reference to FIG. 15.

FIG. 15 is an explanatory view for describing a series of operations of the ink jet printer 1a. In the second embodiment, regarding the waiting for the printing process in the period Ta1, the maintenance process before the printing process in the period Ta2, the maintenance process after the printing process in the period Ta4, and the waiting for the printing process in the period Ta5 are the same as the first embodiment, the description thereof will be omitted.

During the printing process in the period Ta3, even in the second embodiment, the ink jet printer 1a executes the flushing process each time the variable period is ended according to the thickening state of the ink in order to prevent the ink jet printer 1a from causing a discharging failure due to thickening of the ink and from causing image quality deterioration due to thickening of the ink. The ink jet printer 1a in the second embodiment counts the number of ended unit periods Tb among the plurality of unit periods Tb obtained by dividing the period Ta3 required for the printing process in accordance with the division condition for each discharging portion D, that is, manages the counted numbers Cn[1] to Cn[M] corresponding to each of the discharging portions D[1] to D[M].

For any m from 1 to M, when any of the counted numbers Cn[1] to Cn[M] reaches the defined number Spn, the ink jet printer 1a executes the flushing process with respect to the discharging portions D[1] to D[M].

The ink jet printer 1a increases each of the counted numbers Cn[1] to Cn[M] each time the unit period Tb is ended.

The viscosity information μ in the second embodiment is the discharging amount which is the amount of ink discharged from the discharging portion D[m] within one unit period Tb as described above. Specifically, the control portion 6a specifies the total amount of ink discharged from the discharging portions D[1] to D[M] within one unit period Tb as the period discharging amounts Am[1] to Am[M], respectively. For example, the total amount of ink discharged from the discharging portion D[m] within one unit period Tb is specified as the period discharging amount Am[m]. Further, when the period discharging amount Am[m], which is the viscosity information μ[m] of the discharging portion D[m] in one unit period Tb, satisfies the counted number decrease condition, the control portion 6a decreases the counted number Cn[m] corresponding to the discharging portion D[m]. In the following description, the discharging amount, which is the total amount of ink discharged from the discharging portion D[m] in one unit period Tb, is referred to as the “period discharging amount Am[m]”. The period discharging amount Am[m] is, for example, the weight of the ink discharged from the discharging portion D[m] within one unit period Tb.

The period discharging amount Am[m] is an example of “information related to the discharging state of the discharging portion for each period”.

The control portion 6a specifies, for example, the period discharging amount Am[m] for each discharging portion D[m] based on an individual designation signal Sd[m] of each of the plurality of discharging processes included in one unit period Tb. As a specific aspect of the period discharging amount Am[m], for example, there are two aspects shown below. In the first and second aspects, the storage portion 5 stores a discharging amount corresponding to one large dot, a discharging amount corresponding to one medium dot, and a discharging amount corresponding to one small dot. In the first aspect, for each discharging portion D[m], the control portion 6a initializes the period discharging amount Am[m] to 0 when one unit period Tb starts and sequentially adds the discharging amount corresponding to the individual designation signal Sd [m] of each of the plurality of discharging processes to the period discharging amount Am [m] until the one unit period Tb is ended. Specifically, when the individual designation signal Sd[m] is a value that specifies the formation of large dot, the control portion 6a adds the discharging amount corresponding to one large dot stored in the storage portion 5 to the period discharging amount Am[m]. Further, when the individual designation signal Sd[m] is a value that specifies the formation of medium dot, the control portion 6a adds the discharging amount corresponding to one medium dot stored in the storage portion 5 to the period discharging amount Am[m]. Further, when the individual designation signal Sd[m] is a value that specifies the formation of small dot, the control portion 6a adds the discharging amount corresponding to one small dot stored in the storage portion 5 to the period discharging amount Am[m].

In the second aspect, for each discharging portion D[m], the control portion 6a counts the number of times of discharging in the plurality of discharging processes included in one unit period Tb and specifies a value obtained by multiplying the counted number of times of discharging by the discharging amount discharged at one time as the period discharging amount Am[m]. However, since the amount of ink discharged with the large dot, the medium dot, and the small dot is different, for example, for each discharging portion D[m], the control portion 6a counts the number of times of discharging of each of the large dot, the medium dot, and the small dot discharged in the plurality of discharging processes executed within one unit period Tb. When one unit period Tb is ended, the control portion 6a specifies, as the period discharging amount Am[m], the total of a value obtained by multiplying the number of times of discharging of the large dots by the discharging amount corresponding to the large dots, a value obtained by multiplying the number of times of discharging of the medium dots by the discharging amount corresponding to the medium dots, and a value obtained by multiplying the number of times of discharging of the small dots by the discharging amount corresponding to the small dots. In the following description, the specific aspect of the period discharging amount Am[m] will be described as the first aspect from the viewpoint of ease of explanation.

The counted number decrease condition in the second embodiment is that the period discharging amount Am[m] is equal to or greater than a predetermined amount Ath. In the description of the second embodiment, when simply described as the “counted number decrease condition”, it means the counted number decrease condition in the second embodiment. The predetermined amount Ath and the value for decreasing the counted number Cn[m] when the counted number decrease condition is satisfied are determined in advance by a manufacturer or a user of the ink jet printer 1a. Any values may be used as the predetermined amount Ath and the value for decreasing the counted number Cn[m] when the and the counted number decrease condition is satisfied. However, the value for decreasing the counted number Cn[m] when the counted number decrease condition is satisfied is set to a value corresponding to the predetermined amount Ath. For example, the manufacturer of the ink jet printer 1a can guarantee stable discharging from the discharging portion D within the period regardless of the status of the discharging of the ink from the discharging portion D in the period corresponding to one unit period Tb for the viscosity that causes the discharging failure of the ink, determine the discharging amount from the discharging portion D, which can reduce the viscosity of the ink to the viscosity at which the discharging failure of the ink does not occur, as the predetermined amount Ath, and determines the value for decreasing the counted number Cn[m] when the counted number decrease condition is satisfied to 1.

Further, when the period discharging amount Am[m] is equal to or greater than the predetermined amount Ath, the control portion 6a decreases the counted number Cn[m] by a value corresponding to the period discharging amount Am[m]. Specifically, when the period discharging amount Am[m] is a first amount, the control portion 6a decreases the counted number Cn[m] by a first value. Further, when the period discharging amount Am[m] is a second amount, the control portion 6a decreases the counted number Cn[m] by a second value. The first amount and the second amount are equal to or greater than the predetermined amount Ath. The first amount is larger than the second amount, and the first value is larger than the second value. That is, when the period discharging amount Am[m] increases, the control portion 6a increases a decrease number of the counted number Cn[m] accordingly.

FIG. 15 illustrates an example of the printing process in which the defined number Spn is 3 for the discharging portion D[1]. Further, in FIG. 15, the period discharging amount Am[1] and the counted number Cn[1] corresponding to the discharging amount from the discharging portion D[1] within the unit period Tb of each of the unit period Tb1, the unit period Tb2, the unit period Tb3, the unit period Tb4, the unit period Tb5, the unit period Tb6, and the unit period Tb7 are illustrated. Further, it is premised that the period discharging amount Am5[1] of the unit period Tb5 is equal to or greater than the predetermined amount Ath and the counted number decrease condition is satisfied. Furthermore, it is premised that all of each of the unit periods Tb1, Tb2, Tb3, Tb4, Tb6, and Tb7 of the period discharging amounts Am1[1], Am2[1], Am3[1], Am4[1], Am6[1], and Am7[1] are less than the predetermined amount Ath and the counted number decrease condition is not satisfied. Further, it is premised that none of the counted numbers Cn[1] to Cn[M] after the unit period Tb6 is ended reaches the defined number Spn.

The ink jet printer 1a increases the counted number Cn[1] by 1 without decreasing the counted number Cn[1] at the end of each of the unit period Tb1, the unit period Tb2, and the unit period Tb3. At the end of the unit period Tb3, since at least the counted number Cn[1] among the counted numbers Cn[1] to Cn[M] reaches3, which is the defined number Spn, the ink jet printer 1a executes the flushing process with respect to the discharging portions D[1] to D[M]. When the counted number Cn[m] reaches the defined number Spn for each discharging portion D[m], the flushing process may be executed only on the corresponding discharging portion D[m]. However, in that case, since the timing of the flushing process of the discharging portions D[1] to D[M] is shifted, the flushing process of any of the discharging portions D[m] is executed within the period Ta3 required for the printing process, and then the frequency of interrupting the printing process increases and the throughput decreases. Therefore, when any one of the counted numbers Cn[1] to Cn[M] reaches the defined number Spn, it is preferable to perform the flushing process for all the discharging portions D[1] to D[M]. When the flushing process is executed, the counted numbers Cn[1] to Cn[M] are reset. Subsequently, the ink jet printer 1a increases the counted number Cn[1] by 1 without decreasing the counted number Cn[1] at the end of each of the unit period Tb4 and the unit period Tb5. At the end of the unit period Tb5, since the period discharging amount Am5[1] satisfies the counted number decrease condition, the ink jet printer 1a increases the counted number Cn[1] by 1 while decreasing the counted number Cn[1] by 1. Subsequently, the ink jet printer 1a increases the counted number Cn[1] by 1 without decreasing the counted number Cn[1] at the end of each of the unit period Tb6 and the unit period Tb7. As described above, in this example, the counted numbers Cn[1] to Cn[M] after the unit period Tb5 is ended have not reached the defined number Spn. Subsequently, the ink jet printer 1a increases the counted number Cn[1] by 1 without decreasing the counted number Cn[1] at the end of the unit period Tb7. As a result, at the end of the unit period Tb7, since at least the counted number Cn[1] reaches 3, which is the defined number Spn, the ink jet printer 1a executes the flushing process with respect to the discharging portions D[1] to D[M].

### 2.2. Operation During Printing Process in Second Embodiment

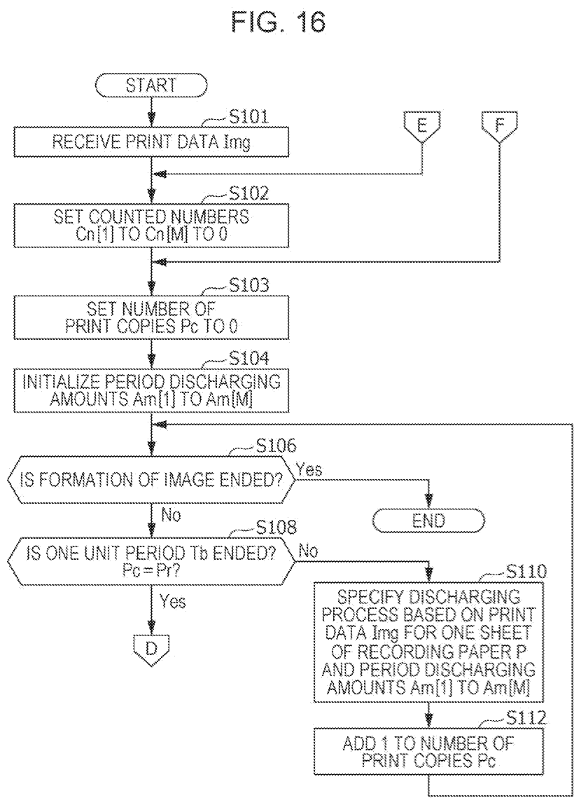

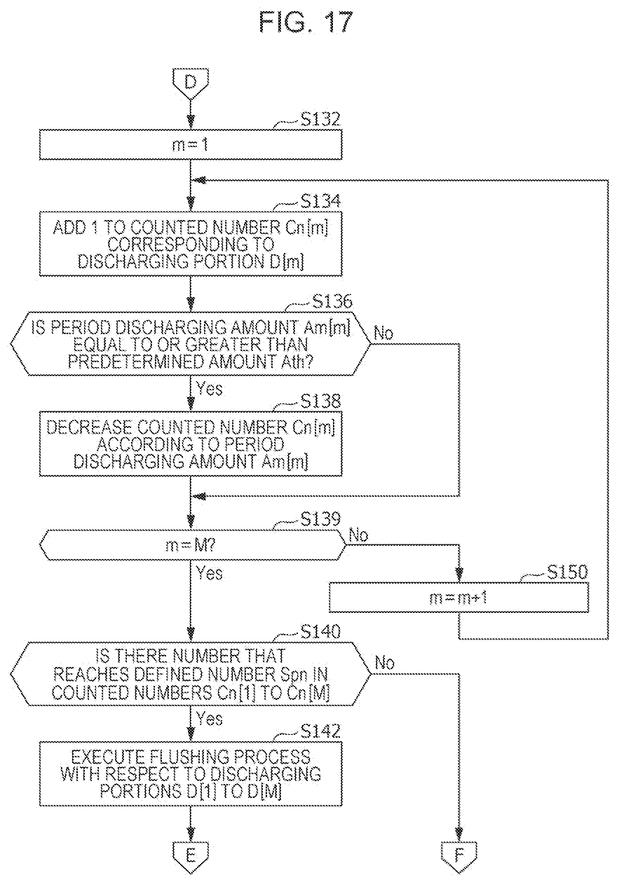

A more detailed operation of the ink jet printer 1a during the printing process will be described with reference to FIGS. 16 and 17. FIGS. 16 and 17 are flowcharts showing the operation of the ink jet printer 1a during the printing process. In step S101, the control portion 6a receives the print data Img from a host computer. Next, in step S102, the control portion 6a sets each of the counted number Cn[1] to Cn[M] to 0.

Further, in the next step S103, the control portion 6a sets a count for measuring one unit period Tb to 0. In the present flowchart, as in the first embodiment, in order to make description by using the first aspect as the division condition for dividing the period Ta3 required for the printing process, in step S103, the control portion 6a sets the number of print copies Pc, which is the number of print copies of the recording paper P, to 0. The case where the second aspect or the third aspect is used as the division condition for dividing the period Ta3 required for the printing process is the same as that of the first embodiment and is omitted in the present embodiment.

Next, in step S104, the control portion 6a initializes the period discharging amounts Am[1] to Am[M], that is, sets the period discharging amounts Am[1] to Am[M] to 0. Subsequently, in step S106, the control portion 6a determines whether or not the formation of the image on the recording paper P is ended.

When the determination result in step S106 is negative, that is, when the image formation is not ended yet, in step S108, the control portion 6a determines whether or not one unit period Tb is ended. For example, it is determined whether or not the number of print copies Pc reaches the Pr sheets of the recording paper P corresponding to one unit period Tb. In the present embodiment, Pr is set to “1”.

When the number of print copies Pc of the recording paper P does not reach the number of print copies Pr corresponding to one unit period Tb, and the determination result in step S108 is negative, that is, when one unit period Tb is not ended, in step S110, the control portion 6a executes printing of one sheet of recording paper P based on the print data Img and specifies the period discharging amounts Am[1] to Am[M] corresponding to the total discharging amount of the ink discharged from the nozzles N of each of the discharging portions D[1] to D[M] when printing one sheet of the recording paper P. For example, the discharging amount, which corresponds to each individual designation signal Sd[m] of the plurality of discharging processes generated based on the print data Img corresponding to one sheet of recording paper P, is added to the period discharging amount Am[m]. Thereby, the period discharging amounts Am[1] to Am[M] corresponding to each of the discharging portions D[1] to D[M] are specified.

Next, in step S112, the control portion 6a executes a process for measuring one unit period Tb according to the execution of printing on the recording paper P in step S110.

In the present flowchart, since the division condition for dividing the period Ta3 required for the printing process is set to the first aspect, the control portion 6a adds 1 to the number of print copies Pc of the recording paper P. Although not illustrated in FIG. 16, in step S110, the liquid discharging head HUa receives a print signal SI generated by the control portion 6b based on the print data Img for each recording period Tu, and each of the discharging portions D[1] to D[M] of the liquid discharging head HUa executes an operation of discharging the ink or not discharging the ink based on the received print signal SI as the discharging process. After the process in step S112 is ended, the ink jet printer 1a returns the process to step S106.

When the number of print copies Pc of the recording paper P reaches the number of print copies Pr corresponding to the unit period Tb and the determination result in step S108 is positive, that is, when one unit period Tb is ended, the control portion 6a substitutes 1 for the variable m in step S132 and adds 1 to the counted number Cn[m] with respect to the discharging portion D[m] in step S134.

Next, in step S136, the control portion 6a determines whether or not the period discharging amount Am[m] corresponding to the viscosity information μ[m] of the discharging portion D[m] satisfies the counted number decrease condition. Specifically, the control portion 6a determines whether or not the period discharging amount Am[m] is equal to or greater than the predetermined amount Ath. When the period discharging amount Am[m] is equal to or greater than the predetermined amount Ath and the determination result in step S136 is positive, that is, when the counted number decrease condition is satisfied, in step S138, the control portion 6a decreases the counted number Cn[m] according to the period discharging amount Am[m] and advances the process to step S139. On the other hand, when the period discharging amount Am[m] is less than the predetermined amount Ath and the determination result in step S136 is negative, that is, when the counted number decrease condition is not satisfied, the control portion 6a advances the process to step S139 without executing the process of step S138.

In step S139, the control portion 6a determines whether or not the variable m matches M, which is the number of discharging portions D. When the determination result in step S139 is negative, that is, when the variable m does not reach M, in step S150, the control portion 6a adds 1 to the variable m and returns the process to step S134. On the other hand, when the determination result in step S139 is positive, that is, when the variable m reaches M, the control portion 6a advances the process to step S140.

In step S140, the control portion 6a determines whether or not there is a number that reaches the defined number Spn in the counted numbers Cn[1] to Cn[M]. When the determination result in step S140 is negative, that is, when there is no number that reaches the defined number Spn in the counted numbers Cn[1] to Cn[M], the control portion 6a returns the process to step S103.

On the other hand, when the determination result in step S140 is positive, that is, when there is a number that reaches the defined number Spn in the counted numbers Cn[1] to Cn[M], in step S142, the control portion 6a executes the flushing process with respect to the discharging portions D[1] to D[M]. However, the control portion 6a returns the process to step S102 after the process in step S142 is ended.

In this way, the period discharging amounts Am[1] to Am[M] are reset each time one unit period Tb is ended. In other words, the period discharging amount Am[m] can be said to be information related to the discharging state for each unit period Tb of the discharging portion D[m].

When the determination result in step S106 is positive, the ink jet printer 1 ends the series of processes illustrated in FIGS. 16 and 17.

### 2.3. Round-up of Second Embodiment

As explained above, for any m from 1 to M, when the period discharging amount Am[m] of the discharging portion D[m] satisfies the counted number decrease condition, the ink jet printer 1a decreases the counted number Cn[m]. Further, when any one of the counted numbers Cn[1] to Cn[M] reaches the defined number Spn, the ink jet printer 1a executes the flushing process.

When the ink is discharged from the nozzle N[m], the thickened ink is discarded and the viscosity of the ink inside the discharging portion D[m] decreases. Therefore, when the period discharging amount Am[m] satisfies the counted number decrease condition, the counted number Cn[m] is decreased, so that the counted number Cn[m] can accurately indicate the thickening state of the ink inside the discharging portions D[m].

Further, for any m from 1 to M, the counted number decrease condition in the present embodiment is that the period discharging amount Am[m], that is, the amount of the ink discharged from the discharging portion D[m] in one unit period Tb is equal to or greater than the predetermined amount Ath.

By appropriately setting the predetermined amount Ath, the counted number Cn[m] can accurately indicate the thickening state of the ink inside the discharging portion D[m].

Further, for any m from 1 to M, when the period discharging amount Am[m] is equal to or greater than the predetermined amount Ath, the control portion 6a decreases the counted number Cn[m] with respect to the discharging portion D[m] by a value corresponding to the period discharging amount Am[m].

In a state in which the thickening of the ink inside the discharging portion D[m] progresses, the degree of elimination of the thickening of the ink in accordance with the increase in the discharging amount from the discharging portion D[m] within the unit period Tb becomes larger. Therefore, by decreasing the counted number Cn[m] by a value corresponding to the period discharging amount Am[m], the counted number Cn[m] can accurately indicate the thickening state of the ink.

### 3. THIRD EMBODIMENT

In the first embodiment, the control portion 6 increases the counted number Cn by 1 each time the unit period Tb is ended and executes the flushing process when the counted number Cn reaches the defined number Spn, but the present embodiment is not limited to this. In the third embodiment, although the control portion 6 measures the viscosity information μ[1] to μ[M] each time the unit period Tb is ended as in the first embodiment, the control portion 6 is different from the first embodiment in that the counted number Cn is not counted and the flushing process is executed when any one of the viscosity information μ[1] to μ[M] is equal to or greater than the predetermined threshold value μbth. Hereinafter, the third embodiment will be described.

Since the configuration of the ink jet printer 1 according to the third embodiment is the same as that of the ink jet printer 1 according to the first embodiment, the description thereof will be omitted. Hereinafter, for the sake of simplicity, the ink jet printer 1 in the third embodiment will be referred to as an ink jet printer 1b , and the control portion 6 in the third embodiment will be referred to as a control portion 6b.

### 3.1. Execution Timing of Flushing Process in Third Embodiment

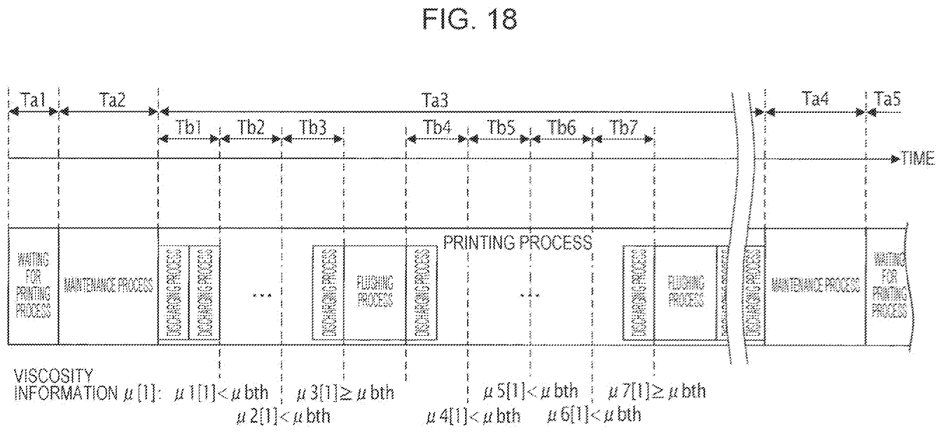

FIG. 18 is an explanatory view for describing a series of operations of the ink jet printer 1b . In the third embodiment, regarding the waiting for the printing process in the period Ta1, the maintenance process before the printing process in the period Ta2, the maintenance process after the printing process in the period Ta4, and the waiting for the printing process in the period Tay are the same as the first embodiment, the description thereof will be omitted.

In the period Ta3, even in the third embodiment, the ink jet printer 1b executes the flushing process each time the variable period is ended according to the thickening state of the ink in order to prevent the ink jet printer 1b from causing a discharging failure due to thickening of the ink and from causing image quality deterioration due to thickening of the ink. In the third embodiment, the ink jet printer 1b measures the viscosity information μ[1] to μ[M] for each of the discharging portions D[1] to D[M] for each unit period Tb obtained by dividing the period Ta3 required for the printing process in accordance with the division condition and executes the flushing process when any one of the viscosity information μ[1] to μ[M] is equal to or greater than the predetermined threshold value μbth. The predetermined threshold value μbth is determined in advance by the manufacturer or the user of the ink jet printer 1b . For example, the manufacturer of the ink jet printer 1b determines the viscosity at which the discharging failure may occur in the discharging portion D by the time when the next unit period Tb elapses as the predetermined threshold value μbth.

In FIG. 18, the viscosity information μ[1] is illustrated at the end of each of the unit period Tb1, the unit period Tb2, the unit period Tb3, the unit period Tb4, the unit period Tb5, the unit period Tb6, and the unit period Tb7. Further, it is premised that the viscosity information μ3[1] and μ7[1] measured at the end of each of the unit periods Tb3 and Tb7 are equal to or greater than the predetermined threshold value μbth. Furthermore, it is premised that all the viscosity information μ1[1] to μ1[M], μ2[1] to μ2[M], μ4[1] to μ4[M], μ5[1] to μ5[M], and μ6[1] to μ6[M] measured at the end of each of the unit periods Tb1, Tb2, Tb4, Tb5, and Tb6 are less than the threshold value μbth.

The ink jet printer 1b measures the viscosity information μ[1] to μ[M] of the discharging portions D[1] to D[M] at the end of each of the unit period Tb1, the unit period Tb2, and the unit period Tb3. Since at least the viscosity information μ3[1] measured at the end of the unit period Tb3 is equal to or greater than the predetermined threshold value μbth, the ink jet printer 1b executes the flushing process with respect to the discharging portions D[1] to D[M]. Further, after the flushing process is executed, the ink jet printer 1b measures the viscosity information μ[1] to μ[M] of the discharging portions D[1] to D[M] at the end of each of the unit period Tb4, the unit period Tb5, the unit period Tb6, and the unit period Tb7. Since the viscosity information μ[1] to μ[M] measured at the end of each of the unit period Tb4, the unit period Tb5, and the unit period Tb6 is less than the predetermined threshold value μbth, the ink jet printer 1b does not execute the flushing process with respect to the discharging portions D[1] to D[M]. Since at least the viscosity information μ7[1] measured at the end of the unit period Tb7 is equal to or greater than the predetermined threshold value μbth, the ink jet printer 1b executes the flushing process with respect to the discharging portions D[1] to D[M].

### 3.2. Operation During Printing Process in Third Embodiment

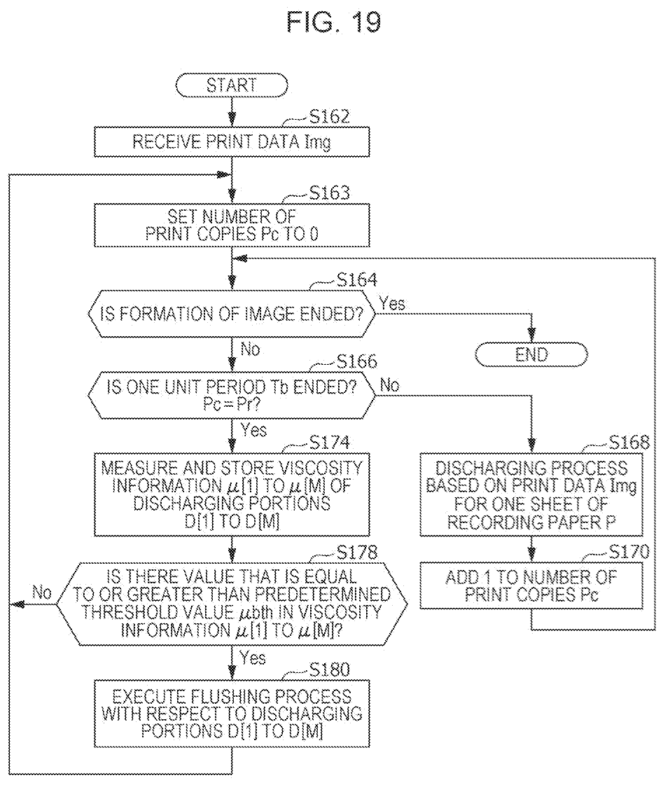

A more detailed operation of the ink jet printer 1b during the printing process will be described with reference to FIG. 19. FIG. 19 are flowcharts showing the operation of the ink jet printer 1b during the printing process. In step S162, the control portion 6b receives the print data Img from a host computer.

Next, in the next step S163, the control portion 6b sets a count for measuring one unit period Tb to 0. In the present flowchart, as in the first embodiment, in order to make description by using the first aspect as the division condition for dividing the period Ta3 required for the printing process, in step S163, the control portion 6b sets the number of print copies Pc, which is the counted number of the number of print copies of the recording paper P, to 0. The case where the second aspect or the third aspect is used as the division condition for dividing the period Ta3 required for the printing process is the same as that of the first embodiment and is omitted in the present embodiment.

Next, in step S164, the control portion 6b determines whether or not the formation of the image on the recording paper P is ended.

When the determination result in step S164 is negative, that is, when the image formation is not ended yet, in step S166, the control portion 6b determines whether or not one unit period Tb is ended. For example, it is determined whether or not the number of print copies Pc reaches the Pr sheets of the recording paper P corresponding to one unit period Tb. In the present embodiment, Pr is set to “1”.

When the number of print copies Pc of the recording paper P does not reach the number of print copies Pr corresponding to one unit period Tb and the determination result in step S166 is negative, that is, when one unit period Tb is not ended, in step S168, the control portion 6b executes printing of one sheet of recording paper P based on the print data Img. Next, in step S170, the control portion 6b executes a process for measuring one unit period Tb according to the execution of printing on the recording paper P in step S168. In the present flowchart, since the division condition for dividing the period Ta3 required for the printing process is set to the first aspect, the control portion 6b adds 1 to the number of print copies Pc of the recording paper P. Although not illustrated in FIG. 19, the liquid discharging head HU receives a print signal SI generated by the control portion 6b based on the print data Img for each recording period Tu, and each of the discharging portions D[1] to D[M] of the liquid discharging head HU executes an operation of discharging the ink or not discharging the ink based on the received print signal SI as the discharging process. After the processing in step S170 is ended, the ink jet printer 1b returns the process to step S164.

When the number of print copies Pc of the recording paper P reaches the number of print copies Pr corresponding to the unit period Tb and the determination result in step S166 is positive, that is, when one unit period Tb is ended, in step S174, the control portion 6b measures the viscosity information μ[1] to μ[M] of the discharging portions D[1] to D[M] and stores the measured viscosity information μ[1] to μ[M] in the storage portion 5.

After the process of step S174 is ended, in step S178, the control portion 6b determines whether or not there is a value equal to or greater than the predetermined threshold value μbth in the viscosity information μ[1] to μ[M]. When there is a value equal to or greater than the predetermined threshold value μbth in the viscosity information μ[1] to μ[M] and the determination result in step S178 is positive, in step S180, the ink jet printer 1b executes the flushing process with respect to the discharging portions D[1] to D[M] and returns the process to step S163.

On the other hand, when there is no value equal to or greater than the predetermined threshold value μbth in the viscosity information μ[1] to μ[M] and the determination result in step S178 is negative, the ink jet printer 1b returns the process to step S163.

When the determination result in step S164 is positive, the ink jet printer 1b ends the series of processes illustrated in FIG. 19.

### 3.3. Round-up of Third Embodiment

As described above, the ink jet printer 1b measures the viscosity information μ each time the unit period Tb is ended and executes the flushing process when the viscosity information μ is equal to or greater than the predetermined threshold value μbth.

According to the third embodiment, since the flushing process is executed each time the variable period according to the thickening state of the ink is ended, it is possible to reduce the number of times of executing the flushing process while maintaining a state in which the discharging failure of the ink does not occur as compared with the aspect in which the flushing process is executed periodically.

### 4. MODIFICATION EXAMPLE

Each embodiment illustrated above may be variously modified. A specific aspect of the modification is exemplified below. Any two or more aspects selected from the following examples can be appropriately combined within a range not inconsistent with each other.

### 4.1. First Modification Example

The viscosity information μ related to the viscosity of the ink in the first embodiment and the third embodiment is a parameter indicating the characteristics of the residual vibration indicated by the residual vibration signal NES, but the viscosity information μ is not limited to this. For example, the viscosity information μ may be any one of the number of times of discharging of the ink, a discharging amount of the ink, a flying speed of the ink, and an amount of deviation of a landing position of a test pattern.

When the viscosity information μ is the flying speed of the ink, after the unit period is ended, the ink jet printer 1 measures each of flying speeds [1] to [M] of droplets discharged from the nozzles N[1] to N[M] of the discharging portions D[1] to D[M] and acquires the measured flying speeds [1] to [M] as the viscosity information μ[1] to μ[M] related to the viscosity of the ink inside the discharging portions D[1] to D[M]. As the thickening of the ink inside the discharging portion D progresses, the flying speed of the droplet discharged from the nozzle N decreases. Therefore, it can be said that the flying speed represents the viscosity of the ink inside the discharging portion D. In order to measure the flying speed of the droplets, the ink jet printer 1 has, for example, a measuring mechanism used for measuring the flying speed at a position in the −Z direction from the liquid discharging head HU. This measuring mechanism has, for example, a light emitting portion that emits some light rays such as infrared rays and ultraviolet rays, and a light receiving portion that receives the above-mentioned light rays when there is no obstacle. First, the measuring mechanism acquires the time when the light rays emitted from the light emitting portion are blocked by the droplets and the light receiving portion does not receive the light rays. Next, the ink jet printer 1 specifies, as a flying period, a period from the time when the piezoelectric element PZ is displaced such that the ink is discharged from the discharging portion D to the time when the light receiving portion does not receive the light rays. A flying distance from a position of the nozzle N to a position where the droplets block the light rays emitted from the light emitting portion is a predetermined distance. Thereafter, the ink jet printer 1 calculates a value obtained by dividing the flying distance by the flying period as the flying speed.

When the viscosity information μ is the amount of deviation of the landing position of the test pattern, while moving the liquid discharging head HU and the recording paper P relative to each other at a predetermined speed, the ink jet printer 1 causes the droplets discharged from the discharging portions D[1] to D[M] to land on the recording paper P, measures the amounts of deviation [1] to [M] of a position where the droplet lands on the recording paper P, and acquires the measured amounts of deviation [1] to [M] as the viscosity information μ[1] to μ[M] related to the viscosity of the ink inside the discharging portions D[1] to D[M]. As the thickening of the ink inside the discharging portion D progresses, the flying speed of the droplet discharged from the nozzle N decreases. Since the liquid discharging head HU and the recording paper P are relatively moving at the predetermined speed, when the flying speed of the droplet discharged from the nozzle N decreases, the time until the droplet land on the recording paper P becomes long, and the relative movement distance between the liquid discharging head HU and the recording paper P during that time becomes long, thereby the position where the droplet lands on the recording paper P deviates from the position where the droplet should originally land. Therefore, it can be said that the amount of deviation represents the viscosity of the ink inside the discharging portion D. In order to measure the amount of deviation, the ink jet printer 1 has an image capturing portion that captures an image of the recording paper P. First, the ink jet printer 1 eliminates the thickening of ink inside the discharging portion D in any of the M discharging portions D arranged along a direction intersecting the relative movement directions between the liquid discharging head HU and the recording paper P to set to the reference discharging portion D-S. Next, while moving the liquid discharging head HU and the recording paper P relative to each other, the ink jet printer 1 simultaneously discharges droplets from the reference discharging portion D-S and the measurement target discharging portion D-M, for which the viscosity of the ink is to be measured, among the M discharging portions D, and causes the droplets to land on the recording paper P. The image capturing portion captures the recording paper P including the droplets discharged from the reference discharging portion D-S and landed on the recording paper P, and the droplets discharged from the measurement target discharging portion D-M and landed on the recording paper P. The ink jet printer 1 acquires image capturing information indicating an image capturing result captured by the image capturing portion. Based on the image capturing information, the ink jet printer 1 specifies a first position of the droplet discharged from the reference discharging portion D-S and landed on the recording paper P and a second position of the droplet discharged from the measurement target discharging portion D-M and landed on the recording paper P, and specifies a distance between the first position and the second position in the relative movement direction between the liquid discharging head HU and the recording paper P as an amount of deviation.

### 4.2. Second Modification Example

In the second embodiment, for any m from 1 to M, although the period discharging amount Am[m] is described as an example of the “information related to the discharging state of the discharging portion for each period”, the “information related to the discharging state of the discharging portion for each period” is not limited to the period discharging amount Am[m]. The information related to the discharging state of the discharging portion D[m] for each unit period Tb may be, for example, the number of times of discharging of the ink discharged by the discharging portion D[m] in one unit period Tb. In a second modification example, the counted number decrease condition, which is the second condition, is that the number of times of discharging of the ink discharged by the discharging portion D[m] in one unit period Tb is equal to or greater than a predetermined number of times. Further, the control portion 6 may count the discharging of the amount of ink corresponding to one small dot as the number of times of discharging “a” times, count the discharging of the amount of ink corresponding to one medium dot as the number of times of discharging “al” times, and count the discharging of the amount of ink corresponding to one large dot as the number of times of discharging “a2” times. “a1” is greater than “a”, and “a2” is greater than “a1”. For example, “a” is 1, “a1” is 2, and “a2” is 3.

### 4.3. Third Modification Example

In the second embodiment, the first modification example, and the second modification example, in other words, in the aspect in which the residual vibration signal NES is not used as the viscosity information μ, a heat generating element that heats the ink inside the cavity 320 may be used instead of the piezoelectric element PZ. In a third modification example, the heat generating element is an example of a “drive element”.

### 4.4. Fourth Modification Example

In the first embodiment and the first modification example based on the first embodiment, the threshold value μth is determined to the viscosity that does not require the flushing process, which corresponds to the viscosity state immediately after the flushing process, the counted number Cn is decreased by the value equal to or greater than the defined number Spn when the counted number decrease condition is satisfied, and the counted number Cn is set to “0”, but the present modification example is not limited to this. For example, the threshold value μth can be determined to be another threshold value μth which is a value between the viscosity of the ink immediately after the flushing process and the viscosity of the ink requiring the flushing process.

In that case, the value for decreasing the counted number Cn when the counted number decrease condition is satisfied is determined to be a value corresponding to the other threshold value μth. When the counted number decrease condition that all of the measured viscosity information μ[1] to μ[M] are equal to or less than the other threshold value μth is satisfied, the counted number Cn may be decreased by a value corresponding to the other threshold value μth.

For example, the maximum viscosity value in a viscosity range in which there is no possibility that a discharging failure occurs in the discharging portion D while one or more unit periods Tb elapses can be determined as another threshold value μth, and when all of the viscosity information μ[1] to the viscosity information μ[M] are equal to or less than the other threshold value μth and the counted number decrease condition is satisfied, the value of the counted number Cn can also be decreased to the value of the defined number Spn−1.

According to a fourth modification example, by decreasing the counted number Cn by a value corresponding to the viscosity information μ, the counted number Cn can accurately indicate the thickening state of the ink.

### 4.5. Fifth Modification Example

In the first embodiment, the first modification example based on the first embodiment, and the fourth modification example, the viscosity information μ[1] to μ[M] are measured each time one unit period Tb is ended but the present modification example is not limited to this. For example, the control portion 6 may change the frequency of measuring the viscosity information μ[1] to μ[M] according to the counted number Cn. For example, the control portion 6 may measure the viscosity information μ[1] to μ[M] each time n1 unit periods Tb are ended when the counted number Cn is equal to or less than a first threshold value, and may measure the viscosity information μ[1] to μ[M] each time n2 unit periods Tb are ended when the counted number Cn is greater than the first threshold value. n1 is larger than n2. The first threshold value is a value smaller than the defined number Spn. The first threshold value is determined by the manufacturer or the user of the ink jet printer 1. For example, when n1 is 2 and n2 is 1, the control portion 6 measures the viscosity information μ[1] to μ[M] each time 2 unit periods Tb are ended when the counted number Cn is equal to or less than a first threshold value, and measures the viscosity information μ[1] to μ[M] each time 1 unit period Tb is ended when the counted number Cn is greater than the first threshold value as in the first embodiment.

According to a fifth modification example, when the counted number Cn is equal to or less than the first threshold value, as compared with the aspect in which the viscosity information μ[1] to μ[M] are measured each time the unit period Tb of the number of pieces less than n1 is ended, the control portion 6 can reduce the frequency of measuring the viscosity information μ[1] to μ[M], thereby the throughput can be improved. Further, when the counted number Cn is greater than the first threshold value, as compared with the aspect in which the viscosity information μ[1] to μ[M] are measured each time n1 unit periods Tb are ended, the control portion 6 can easily detect a state more quickly in which a discharging failure may occur due to the thickening of the viscosity of the ink, by increasing the frequency of measuring the viscosity information μ[m]. As a result, it becomes easy to secure good printing quality without lengthening the period Ta3 required for the printing process.

### 4.6. Sixth Modification Example

In the first embodiment, the first modification example based on the first embodiment, the fourth modification example, and the fifth modification example, the execution timing of the flushing process is determined by the common counted number Cn with respect to the discharging portions D[1] to D[M], but the present modification example is not limited to this. For example, the counted number Cn[m] may be managed individually for each of the discharging portions D[1] to D[M], the value of the ended unit period Tb may be added to the counted number Cn[m], and when the viscosity information μ[m] is equal to or less than the threshold value μth, the counted number Cn[m] may be decreased. In this case, the flushing process may be executed in all of the discharging portions D[1] to D[M] when any of the counted numbers Cn[m] reaches the defined number Spn.

### 4.7. Seventh Modification Example

In the second embodiment, the second modification example, the third modification example based on the second embodiment or the second modification example, and the sixth modification example, the control portion 6 manages the counted numbers Cn[1] to Cn[M] for each of the discharging portions D[1] to D[M] and executes the flushing process in all of the discharging portions D[1] to D[M] when the counted number Cn[m] of any of the counted numbers Cn[1] to Cn[M] reaches the defined number Spn, but the present modification example is not limited to this. For example, the flushing process can be executed only for the discharging portion D[m] corresponding to the counted number Cn[m] that reaches the defined number Spn. According to this aspect, the number of times of executing the flushing process for the liquid discharging head HU increases, but it is possible to discard an appropriate amount of ink suitable for each of the plurality of discharging portions D according to the variation in the thickening degree of the discharging portion D[1] to the discharging portion D[M].

### 4.8. Eighth Modification Example

Among the above-described aspects, in the aspect using the residual vibration as in the first embodiment, although an inspection waveform PS is defined such that the discharging portion D[m] is driven to such an extent that the ink is not discharged, the inspection waveform PS may be defined such that the discharging portion D[m] is driven to such an extent that the ink is discharged. However, when the inspection waveform PS is defined such that the discharging portion D[m] is driven to such an extent that the ink is discharged, the ink jet printer 1 executes the discharging state determination process at a position where the liquid discharging head HU does not overlap with the recording paper P when viewed in the Z axis direction.

### 4.9. Ninth Modification Example

In each of the above-described aspects, the serial-type ink jet printer 1 in which a transporting body 82 accommodating the liquid discharging head HU is reciprocated in the X axis direction is exemplified, but the present disclosure is not limited to such an aspect. The ink jet printer may be a line-type ink jet printer in which a plurality of nozzles N are distributed over the entire width of the recording paper P. The division condition in the ninth modification example is any one of the first aspect and the third aspect described in the first embodiment. 4.10. Tenth Modification Example

The ink jet printer exemplified in each of the above-described aspects can be adopted not only in an apparatus dedicated to printing but also in various apparatus such as a facsimile apparatus and a copying machine. Moreover, the application of the liquid discharging apparatus of the present disclosure is not limited to printing. For example, a liquid discharging apparatus that discharges a solution of a coloring material is utilized as a manufacturing apparatus that forms a color filter of a liquid crystal display apparatus. Further, a liquid discharging apparatus that discharges a solution of a conductive material is utilized as a manufacturing apparatus that forms wiring and electrodes of a wiring substrate. 5. Appendix

From the above-exemplified embodiment, for example, the following configuration can be ascertained.

A maintenance method for a liquid discharging apparatus according to a first aspect that is a preferred aspect is a maintenance method for a liquid discharging apparatus executing a printing process of forming an image indicated by print data on a medium and including a liquid discharging head that includes a nozzle that discharges liquid, a pressure chamber that communicates with the nozzle, and a drive element that applies a pressure fluctuation to the liquid inside the pressure chamber, in which the printing process includes a discharging process of driving the drive element according to the print data to discharge the liquid from the liquid discharging head and making the liquid land on the medium, and a maintenance process of driving the drive element to discard the liquid inside the liquid discharging head, and the maintenance method includes: counting a unit period number, which is the number of ended unit periods among a plurality of unit periods obtained by dividing a period required for the printing process in accordance with a first condition, during the printing process; executing the maintenance process when the unit period number reaches a defined number; acquiring viscosity information related to viscosity of the liquid inside the liquid discharging head before the unit period number reaches the defined number; and decreasing the unit period number when the viscosity information satisfies a second condition.

In the first aspect, the timing of executing the maintenance process is adjusted according to the unit period number which can be said to be a value estimated the thickening state of the ink inside the liquid discharging head. Therefore, as compared with the aspect in which maintenance process is executed periodically, the liquid discharging apparatus according to the first aspect can reduce the number of times of executing the maintenance process in a state in which the discharging failure of the liquid does not occur, that is, while ensuring good printing quality. By reducing the number of times of executing the maintenance process, it is possible to reduce the waste of liquid and improve the throughput.

In a second aspect, which is a specific example of the first aspect, the viscosity information may be a parameter corresponding to the viscosity of the liquid inside the liquid discharging head, and the maintenance method may further include: measuring the parameter corresponding to the viscosity of the liquid inside the liquid discharging head each time one unit period of the plurality of unit periods is ended; and decreasing the unit period number when the measured parameter satisfies the second condition.

When the viscosity information satisfies the second condition, it indicates that the thickening of the liquid inside the liquid discharging head is going to be eliminated. Therefore, by decreasing the unit period number when the second condition is satisfied, the unit period number can accurately indicate the thickening state of the liquid inside the liquid discharging head. According to the second aspect, by accurately indicating the thickening state of the liquid by using the unit period number, it is possible to suppress the execution of the maintenance process even though the thickening of the liquid has not progressed.

In a third aspect, which is a specific example of the second aspect, the liquid discharging head may include a plurality of discharging portions each including the nozzle, the pressure chamber, and the drive element, the viscosity information may be a parameter corresponding to viscosity of the liquid inside each of the plurality of discharging portions, and the maintenance method may further include: measuring the parameter corresponding to the viscosity of the liquid inside each of the plurality of discharging portions; and setting the unit period number to 0 when the parameters of all the discharging portions of the plurality of discharging portions are equal to or less than viscosity that does not require the maintenance process.

According to the third aspect, by setting the unit period number for all of the plurality of discharging portions to 0, it is possible to reduce the number of times of executing the maintenance process while maintaining the state in which the discharging failure of the liquid does not occur.

In a fourth aspect, which is a specific example of the second aspect or the third aspect, the liquid discharging head may include the plurality of discharging portions each including the nozzle, the pressure chamber, and the drive element, and the maintenance method may further include: executing the maintenance process when there is a parameter that is equal to or greater than viscosity that requires the maintenance process among the parameters of the plurality of discharging portions.

According to the fourth aspect, it is possible to reduce the occurrence of the discharging failure of the liquid by executing the maintenance process when there is a parameter equal to or greater than the viscosity that requires the maintenance process.

In a fifth aspect, which is a specific example of the first aspect, the liquid discharging head may include a plurality of discharging portions each including the nozzle, the pressure chamber, and the drive element, the viscosity information may be information related to a discharging state of the discharging portion for each unit period, and the maintenance method may further include: counting the unit period number for each of the plurality of discharging portions; acquiring the viscosity information for each of the plurality of discharging portions; in counting the unit period number corresponding to each of the plurality of discharging portions, when a corresponding viscosity information satisfies the second condition, decreasing a corresponding unit period number; and when at least one of the unit period numbers corresponding to the plurality of discharging portions reaches the defined number, executing the maintenance process with respect to the plurality of discharging portions.

When the liquid is discharged from the nozzle, the thickened liquid is discarded and the viscosity of the liquid inside the discharging portion is reduced. Therefore, according to the fifth aspect, when the information related to the discharging state of the discharging portion satisfies the second condition, the unit period number can accurately indicate the thickening state of the liquid inside the discharging portion by decreasing the unit period number.

In a sixth aspect, which is a specific example of the fifth aspect, the information related to the discharging state of the discharging portion for each unit period may be a total amount of liquid discharged from the discharging portion within the unit period, and the second condition may be that the total amount of liquid discharged from the discharging portion within the unit period is equal to or greater than a predetermined amount.

According to the sixth aspect, by appropriately setting the predetermined amount, the unit period number can accurately indicate the thickening state of the liquid inside the discharging portion.

In a seventh aspect, which is a specific example of the sixth aspect, in counting the unit period number corresponding to each of the plurality of discharging portions, the maintenance method may further includes: when a total amount of liquid discharged from the corresponding discharging portion within the unit period is a first amount, which is equal to or greater than the predetermined amount, decreasing the corresponding unit period number by a first value; and when the total amount of liquid discharged from the corresponding discharging portion within the unit period is a second amount, which is equal to or greater than the predetermined amount, decreasing the corresponding unit period number by a second value, and the first amount may be greater than the second amount, and the first value may be greater than the second value.

In a state in which the thickening of the liquid has progressed, the degree of elimination of the thickening of the liquid increases as the discharging amount of the discharging portion increases. Therefore, according to the seventh aspect, by decreasing the unit period number by a value corresponding to the amount of liquid discharged from one discharging portion, the unit period number can accurately indicate the thickening state of the liquid.

What is claimed is:

1. A maintenance method for a liquid discharging apparatus executing a printing process of forming an image indicated by print data on a medium and including a liquid discharging head that includes a nozzle that discharges liquid, a pressure chamber that communicates with the nozzle, and a drive element that applies a pressure fluctuation to the liquid inside the pressure chamber, wherein
the printing process includes a discharging process of driving the drive element according to the print data to discharge the liquid from the liquid discharging head and making the liquid land on the medium, and a maintenance process of driving the drive element to discard the liquid inside the liquid discharging head, and
the maintenance method comprises:
counting a unit period number, which is the number of ended unit periods among a plurality of unit periods obtained by dividing a period required for the printing process in accordance with a first condition, during the printing process;
executing the maintenance process when the unit period number reaches a defined number;
acquiring viscosity information related to viscosity of the liquid inside the liquid discharging head before the unit period number reaches the defined number; and
decreasing the unit period number when the viscosity information satisfies a second condition.

2. The maintenance method according to claim 1, wherein
the viscosity information is a parameter corresponding to the viscosity of the liquid inside the liquid discharging head, and
the maintenance method further comprises:
measuring the parameter corresponding to the viscosity of the liquid inside the liquid discharging head each time one unit period of the plurality of unit periods is ended; and
decreasing the unit period number when the measured parameter satisfies the second condition.

3. The maintenance method according to claim 2, wherein
the liquid discharging head includes a plurality of discharging portions each including the nozzle, the pressure chamber, and the drive element, and
the maintenance method further comprises:
executing the maintenance process when there is a parameter that is equal to or greater than viscosity that requires the maintenance process among the parameters corresponding to the plurality of discharging portions.

4. The maintenance method according to claim 2, wherein
the liquid discharging head includes a plurality of discharging portions each including the nozzle, the pressure chamber, and the drive element,
the viscosity information is a parameter corresponding to viscosity of the liquid inside each of the plurality of discharging portions, and
the maintenance method further comprises:
measuring the parameter corresponding to the viscosity of the liquid inside each of the plurality of discharging portions; and
setting the unit period number to 0 when the parameters corresponding to all the discharging portions of the plurality of discharging portions are equal to or less than viscosity that does not require the maintenance process.

5. The maintenance method according to claim 4, wherein
the maintenance method further comprises:
executing the maintenance process when there is a parameter that is equal to or greater than viscosity that requires the maintenance process among the parameters corresponding to the plurality of discharging portions.

6. The maintenance method according to claim 1, wherein
the liquid discharging head includes a plurality of discharging portions each including the nozzle, the pressure chamber, and the drive element,
the viscosity information is information related to a discharging state of the discharging portion for each unit period, and
the maintenance method further comprises:
counting the unit period number for each of the plurality of discharging portions;
acquiring the viscosity information for each of the plurality of discharging portions;
in counting the unit period number corresponding to each of the plurality of discharging portions, when a corresponding viscosity information satisfies the second condition, decreasing a corresponding unit period number; and
when at least one of the unit period numbers corresponding to the plurality of discharging portions reaches the defined number, executing the maintenance process with respect to the plurality of discharging portions.

7. The maintenance method according to claim 6, wherein
the information related to the discharging state of the discharging portion for each unit period is a total amount of liquid discharged from the discharging portion within the unit period, and
the second condition is that the total amount of liquid discharged from the discharging portion within the unit period is equal to or greater than a predetermined amount.

8. The maintenance method according to claim 7, wherein
in counting the unit period number corresponding to each of the plurality of discharging portions,
the maintenance method further comprises:
when a total amount of liquid discharged from the corresponding discharging portion within the unit period is a first amount, which is equal to or greater than the predetermined amount, decreasing the corresponding unit period number by a first value; and
when the total amount of liquid discharged from the corresponding discharging portion within the unit period is a second amount, which is equal to or greater than the predetermined amount, decreasing the corresponding unit period number by a second value, and
the first amount is greater than the second amount, and the first value is greater than the second value.
